(19) United States
(12) Patent Application Publication
(10) Pub. No.: US 2023/0126550 A1
(43) Pub. Date: Apr. 27, 2023

(54) MICROWAVE HEATING APPLIED TO BIOMASS AND RELATED FEATURES

(71) Applicant: A.L.M. Holding Co., Onalaska, WI (US)

(72) Inventors: Drew J. Frederixon, Rockland, WI (US); Gerald H. Reinke, La Crosse, WI (US); Jacob G. Hehir, Cameron, WI (US); Michael R. Byrnes, Sarona, WI (US); Vernon R. Hegg, Plymouth, MN (US)

(21) Appl. No.: 17/859,473

(22) Filed: Jul. 7, 2022

Related U.S. Application Data
(60) Provisional application No. 63/270,109, filed on Oct. 21, 2021.
(60) Provisional application No. 63/272,905, filed on Oct. 28, 2021.

(51) Int. Cl. C10L 5/44; H05B 6/80; H05B 6/78

(52) U.S. Cl. CPC C10L 5/44; H05B 6/80; H05B 6/78; H05B 6/76

(57) ABSTRACT

Systems and methods of processing biomass include a conveyor unit associated with an inlet and/or outlet, a microwave generator, a microwave guide connecting the microwave generator to the conveyor unit that includes a microwave opening configured to receive microwave energy via the microwave guide, and a microwave suppression system including a tunnel associated with the material inlet and/or outlet, and including at least one flexible and/or movable microwave reflecting component within the tunnel, the microwave reflecting component configured to be deflected as biomass material passes through the tunnel and then returning to a resting, closed position when the biomass material is no longer passing through the tunnel. The conveyor unit is configured to receive and process the biomass material, including heating the biomass material to at least a first temperature by applying microwave energy to the biomass material.

### CROSS REFERENCE TO RELATED APPLICATIONS

This application claims priority to and the benefit of U.S. Provisional Patent Application No. 63/270,109, filed Oct. 21, 2021, and U.S. Provisional Patent Application No. 63/272,905, filed Oct. 28, 2021, the entire contents of which are incorporated herein by reference in their entireties.

### BACKGROUND

Microwave energy can be radiated within an enclosure to process materials. Molecular agitation within the material resulting from its exposure to microwave energy provides energy for thermal treatment or pre-treatment of the material, such as the thermo-chemical processes of conversion or combustion of biomass to produce any of: various gases, including gaseous fuels or other combustible gases, and/or production of liquid fuels (e.g., bio-oils, and the like), and various solids, (e.g., as char [biochar], solid fuels, and the like), and/or direct production of thermal, electrical, or other output energy.

Biomass is an important energy source. Biomass is often characterized as a sustainable, renewable fuel and can be carbon neutral because during its full lifecycle it consumes CO₂ from the atmosphere during growth. CO₂ as a primary greenhouse gas (GHG) is widely believed to be a major contributor to climate change. Reducing CO₂ emissions is a significant advantage of utilizing biomass as an energy source. The Intergovernmental Panel on Climate Change (IPCC) has classified biomass, a form of bioenergy, as a form of renewable energy. Biomass can be converted to gas or liquid fuels (using, e.g., gasification, anaerobic digestion, pyrolysis, fermentation, and/or transesterification) (sometimes referred to as “biofuels” or “bio-oils”), to various intermediate solids, heat and power, and chemicals. Biomass, especially once treated, can in some cases be used for heat and power generation for industrial and utility-scale applications, such as use in direct combustion or co-firing (replacing a portion of the coal with biomass in coal-fired plants). In other cases, biomass can be used in residential, transportation, commercial, industrial, etc. and various other settings as an energy source or fuel.

Heating the biomass material using microwave energy can take a certain amount of time based on the quantity, chemical composition of material, moisture content, a desired final heating temperature, and other factors specific to the intended use of the material in its final processed form. In many cases, logistical limitations (e.g., transportation and storage) have an outsized impact on the viability of biomass as a sustainable energy source.

There also exist challenges related to mobile deployment of heating systems for dry or wet biomass (i.e., less than or more than fifty-percent water content, respectively) and related material processing, particularly in areas where a reliable permanent power source may not be present.

Some government agencies allocate frequency bands centered at 915 MHz and 2450 MHz for use in microwave heating systems. The intensity of the microwave energy that is permitted to leak is sometimes restricted to less than 10 milliwatts (mW) per centimeter squared.

Many industrial microwave heating applications require that there be access apertures into the enclosure so that materials may be continuously transported utilizing such as, for example, a conveyor unit or other mechanism. There is a desire for suppression of microwave energy from these apertures. Continuous microwave heating arrangements have presented a problem that is more complex than the suppression of microwave energy from a simpler batch microwave system.

While applying microwave heating to materials, such as moisture-containing particles, a problem can include preventing microwaves from escaping to an inlet and/or an outlet/discharge region from a channel or region where the microwaves are applied. This can be handled at present by introducing material through a metal grate including two by two inch (5.1 by 5.1 cm) square channels. The same type of grate and channels can be employed on an outlet end. However, these grates have limitations. For example, granular materials or particles (such as moisture-laden granular materials) are sometimes introduced through a square channel system. In these systems, a blockage or slowdown in the process can occur. For instance, larger chunks of material may have difficulty passing through the grates unless the size of the grate's square metal channels are increased accordingly.

Other technological approaches are currently used to prevent potential harmful effects of microwave emissions, but can be less flexible than desirable. For example, other ways of suppressing microwave energy from escaping from a microwave system as a product or material is moving through can include, for example, water jackets or reflectors.

There remains a desire to improve microwave suppression, especially in continuous microwave heating systems. There also remains a desire to provide biomass heating and treatment systems that can be deployed as needed.

### SUMMARY

This disclosure relates to microwave-based heating methods and systems for improving material processing, especially as applied to various biomass materials and processing operations thereof. In particular, embodiments of this disclosure relate to a continuous system for using a microwave heating process at the point of extraction, such as at or near a biomass site or biomass material repository, such as a pile, silo, trucking or railroad facility, forest, farm, or other biomass source (natural or otherwise), whether pre-treated or otherwise. Alternatively, the microwave heating and treatment process can be conducted at a processing facility located a distance from a biomass material storage or origin site, for example. The disclosed continuous systems can be used in any suitable location, and can be stationary/permanent or mobile in various embodiments. Also disclosed and contemplated are batch-type systems for thermally and/or mechanically treating various biomass materials from which desirable downstream biomass products can be produced, including improved consistency and logistics, among other benefits. The microwave heating aspects can be used alone, or in combination (parallel or sequential) with various fluidized bed reactors for supplemental heating of the biomass material.

Therefore, as contemplated herein, a microwave-based thermal pre-treatment, treatment, processing, conversion, and/or combustion biomass process converts a quantity of received biomass material into a homogeneous, high energy density bioenergy carrier with favorable logistical characteristics and end-use properties, that addresses difficult biomass properties, e.g., at the source. Improvements contemplated herein also relate to streamlining storage and transportation of biomass, including leveraging existing logistic infrastructures (such as used for coal, oil, and gas), and allowing for more conventional trading schemes as commonly done with other transportable commodity fuels. Some desirable and/or transportable biomass end products that can be produced according to various embodiments herein include liquid biofuels and biooils, biomass-derived gases, solids and semi-solids (e.g., char, biochar), and the like.

According to the present disclosure, modular heating systems can be arranged to sequentially arrange multiple conveyor units, mechanical processors, and lifting units. Further arrangements provide at least partially parallel arrangements of multiple conveyor units, optionally in combination with sequential arrangements. Disclosed embodiments are fully scalable according to particular desired requirements and specifications.

Also disclosed are embodiments of a microwave energy suppression tunnel and system with one or more flexible or bendable (e.g., steel) microwave reflecting components, such as mesh flaps, for substantially reducing or preventing the leakage of microwave energy from a microwave vessel, e.g., on a conveyor unit, while having a continuous flow of biomass material through the vessel and suppression tunnels. The suppression tunnels can be installed on the inlet and the outlet side of the vessel and are sized to suppress leakage of the microwaves produced by the microwave system, whatever the size of the product or material.

Stated differently, embodiments of the invention include the addition of at least one microwave energy suppression tunnel configured for substantially preventing the leakage of microwave energy from one or more access openings in a microwave energized system while the biomass material to be heated is flowing, e.g., continuously, through the microwave vessel, including, for example, a trough of a conveyor unit also fitted with a helical auger within a housing. The suppression tunnel can be used at inlets and/or outlets of the microwave energy system, and in some embodiments each suppression tunnel comprises a rectangular, U-shaped, or other suitably shaped tunnel about three feet or more in length installed flat or at an angle of preferably no more than about 45 degrees with multiple plies or layers of steel or other microwave material, such as metallic shielding mesh attached to the inner top of the rectangular or U-shaped tunnel or trough. The size of biomass material(s) to be heated can be used as a guideline for adjusting tunnel or trough size for various embodiments. The tunnel and trough of the heating system can be sized and shaped differently in various embodiments.

Flexible or bendable mesh shielding (e.g., in the form of flaps) can be spaced at various intervals and be the same cross-sectional size as the tunnel in which they are mounted. The shielding mesh preferably operates to absorb, deflect, or block various frequency ranges, preferably from about 1MHz to 50GHz in radio frequency (RF) and low frequency (LF) electric fields.

According to a first aspect of the present disclosure, a system for processing biomass material is disclosed. According to the first aspect, the system includes a material inlet and a material outlet. The system also includes at least a first conveyor unit associated with at least one of the material inlet and the material outlet. The system also includes at least one microwave generator. The system also includes at least a first microwave guide operatively connecting the at least one microwave generator to at least the first conveyor unit. Also, according to the first aspect, the first conveyor unit is provided in a first housing that includes at least one microwave opening configured to receive microwave energy via at least the first microwave guide. The system also includes at least one microwave suppression system associated with the first conveyor unit. Also, according to the first aspect, each microwave suppression system includes a tunnel associated with at least one of the material inlet and the material outlet. Each microwave suppression system also includes at least one flexible and/or movable microwave reflecting component included within the tunnel, where at least a portion of the at least one microwave reflecting component is configured to be deflected as a quantity of biomass material passes through the tunnel and then to return to a resting, closed position when the biomass material is no longer passing through the tunnel. Also, according to the first aspect, the first conveyor unit is configured to receive and process the biomass material, the processing including heating the biomass material to at least a first temperature by applying microwave energy to the biomass material within the first housing.

According to a second aspect of the present disclosure, an apparatus for processing biomass material is disclosed. According to the second aspect, the apparatus includes a material inlet and a material outlet. The apparatus also includes a conveyor unit including an auger having an auger shaft provided along an auger rotational axis, the auger configured to rotate in a direction such that a quantity of biomass material received at the conveyor unit is caused to be transported according to the auger rotational axis. The apparatus also includes at least one microwave energy generator, each microwave energy generator being operatively connected to at least a respective microwave guide configured to cause microwaves emitted by the microwave energy generator to heat the biomass material within the conveyor unit by converting the microwaves to heat when absorbed by at least a portion of the biomass material within the conveyor unit. The apparatus also includes at least a first microwave suppression system including a tunnel associated with at least one of the material inlet and material outlet, where the first microwave suppression system includes at least one flexible and/or movable microwave reflecting component within the tunnel, where the at least one microwave reflecting component is configured to absorb, deflect, or block microwave energy, and where the at least one microwave reflecting component is configured to be deflected as the biomass material passes through the tunnel and then to return to a resting, closed position when the biomass material is no longer passing through the tunnel. According to the second aspect, the biomass material is heated using the microwave energy, and where the biomass material is caused to be heated to at least a first temperature by the microwaves emitted by the at least one microwave generator.

According to a third aspect of the present disclosure, a method of processing biomass material using microwave energy is disclosed. According to the third aspect, the method includes receiving a quantity of biomass material at a conveyor unit, where the biomass material passes through at an inlet microwave suppression tunnel before entering the conveyor unit, where the inlet microwave suppression tunnel includes at least one flexible and/or movable inlet microwave reflecting component within the inlet microwave suppression tunnel, and where the at least one inlet microwave reflecting component is configured to absorb, deflect, or block microwave energy. The method also includes deflecting the at least one inlet microwave reflecting component as the biomass material passes through the inlet microwave suppression tunnel and then optionally returning the at least one inlet microwave reflecting component to a resting, closed position when the biomass material is no longer passing through the inlet microwave suppression tunnel. The method also includes transporting the biomass material using at least the conveyor unit. The method also includes heating the biomass material within at least the conveyor unit using at least one microwave generator operatively connected to a respective microwave guide configured to cause microwaves emitted by the microwave energy generator to heat the biomass material within at least the conveyor unit by converting the microwaves to heat when absorbed by at least a portion of the biomass material within at least the conveyor unit. The method also includes causing the biomass material to exit through an outlet microwave suppression tunnel after the biomass material is heated such that the biomass material: a) reaches a first temperature and/or b) undergoes a reaction within at least the conveyor unit.

Mechanical processing, including comminution (crushing or grinding), sizing, sorting, screening, filtering, blending, mixing, cooling/freezing, and/or introduction of liquids steps are also contemplated in order to improve biomass material processing performance.

### DESCRIPTION OF THE DRAWINGS

FIG. 1 is a side view of a portable, continuous material processing system, according to various embodiments.

FIG. 2 is a side view of trough and suppression tunnel components of the continuous material processing system of FIG. 1

FIG. 3 is a top view of the continuous material processing system of FIG. 1.

FIG. 4 is a perspective exploded view of the trough of the continuous material processing system of FIG. 1.

FIG. 5 is a top view of the trough of the continuous material processing system of FIG. 1.

FIG. 6 is a top view of an auger for use with the trough of the continuous material processing system of FIG. 1.

FIG. 7 is a perspective view of an alternative trough for use with the continuous material processing system of FIG. 1.

FIG. 8 is a partial cut-away view of the alternative trough of FIG. 7.

FIG. 9 is a top view of the alternative trough of the continuous material processing system of FIG. 1.

FIG. 10 is a perspective view of a multi-conveyor continuous material processing system, according to various embodiments.

FIG. 11 is a top view of the multi-conveyor continuous material processing system of FIG. 10.

FIG. 12 is a perspective view of a mechanical processing apparatus for use with the multi-conveyor continuous material processing system of FIG. 10.

FIG. 13 is a partial cut-away view of the mechanical processing apparatus of FIG. 12.

FIG. 14 is a perspective view of a mobile multi-conveyor unit continuous material processing system, according to various embodiments.

FIG. 15 is a perspective view of an alternative mobile multi-conveyor continuous material processing system, according to various embodiments.

FIG. 16 is a perspective view of a microwave suppression tunnel, according to various embodiments.

FIG. 17 is a partial cut-away view of the microwave suppression tunnel of FIG. 16.

FIG. 18 is cross-sectional side view of the microwave suppression tunnel of FIG. 16, showing multiple flaps in a closed position.

FIG. 19 is cross-sectional side view of the microwave suppression tunnel of FIG. 16, showing multiple flaps in an open position as flowing material passes the flaps.

FIG. 20 is a front view of an alternative arrangement mesh strip flap for use in a microwave suppression tunnel.

FIG. 21 is a perspective view of the alternative arrangement mesh strip flap of FIG. 20.

FIG. 22 is a cross-sectional side view of a U-shaped microwave suppression tunnel of an outlet side.

FIG. 23 is a cross-sectional top view of the U-shaped microwave suppression tunnel of FIG. 22.

FIG. 24 is a cross-sectional side view of a U-shaped microwave suppression tunnel of an inlet side.

FIG. 25 is a cross-sectional side view of a rectangular microwave suppression tunnel of an inlet side.

FIG. 26 is a cross-sectional top view of a rectangular microwave suppression tunnel of FIG. 25.

FIG. 27 is a cross-sectional side view of a rectangular microwave suppression tunnel of an outlet side.

FIG. 28 is a schematic side view of a hardware detail section of a non-looped microwave absorbing flap with a mesh attached to a microwave suppression tunnel.

FIG. 29A is a cross-sectional end view of a U-shaped microwave suppression tunnel configuration with a top-mounted pivoting mesh flap in a closed position.

FIG. 29B is a cross-sectional end view of the U-shaped microwave suppression tunnel configuration of FIG. 29A with the mesh flap in a partially open position.

FIG. 29C is a cross-sectional end view of the U-shaped microwave suppression tunnel configuration of FIG. 29A with the mesh flap in a fully open position.

FIG. 30A is a cross-sectional end view of a rectangular microwave suppression tunnel configuration with a top-mounted pivoting mesh flap in a closed position.

FIG. 30B is a cross-sectional end view of the rectangular microwave suppression tunnel configuration of FIG. 30A with the mesh flap in a partially open position.

FIG. 30C is a cross-sectional end view of the rectangular microwave suppression tunnel configuration of FIG. 30A with the mesh flap in a fully open position.

FIG. 31 shows various alternative chute cross-sectional shapes of a microwave suppression tunnel.

FIG. 32 is a flowchart of a process according to various embodiments of the present disclosure.

FIG. 33 is a detail view of an RFI shielding mesh according to various embodiments.

FIG. 34 is another view of the RFI shielding mesh of FIG. 33.

FIG. 35 is a transmission damping chart of the shielding mesh according to FIG. 33.

FIG. 36 is a detail view of another shielding mesh according to various embodiments.

FIG. 37 is another view of the shielding mesh of FIG. 36.

FIG. 38 is a transmission damping chart of the shielding mesh of FIG. 36.

FIG. 39 is a perspective view of another embodiment of a portable, continuous material processing system.

FIG. 40 is a flowchart of a process according to various embodiments of the present disclosure.

FIG. 41 is a flowchart of another process according to various embodiments.

FIG. 42 is a flowchart of yet another process according to various embodiments.

### DETAILED DESCRIPTION

According to the present disclosure, many challenges currently exist related to processing and logistics of biomass and related materials. Biomass material is an important energy source, and various solid, gases, liquids, and output energy, including thermal and electrical energy, can be produced from received biomass material. Biomass material, and byproducts produced therefrom, have numerous uses and the above list is not intended to be exhaustive.

Biomass materials, including raw biomass, can include material types such as woody, energy-based crops, forest-based materials, yard-based materials, and agricultural or farm-based materials forest, including various forms of waste materials. Biomass materials can typically include cellulose, lignin, hemicellulose, inorganic substances, among other components, pending on various factors such as soil, age, planting conditions, etc. Examples of organic plant or animal material can collectively be referred to as biomass or biomass material herein. Further examples of biomass materials contemplated, include municipal solid waste, manufacturing waste, landfill gas, sewage sludge, algae (including algal lipids), sugar cane, corn, straw, husk, etc. Yet further examples of biomass materials include various grasses and trees, such as safari grass, miscanthus grass, napier grass, pines, acacia, poplar, willow, eucalyptus, leucaena, pinus, dalbergia, Junniperus sabina, Picea abies, and the like, although this list is not intended to be exhaustive and any other organic plant or animal material, and any combinations thereof, are also contemplated. Also contemplated are plants and weeds that grow underwater, such as seaweeds, milfoils, and the like. Raw biomass as used herein refers to biomass material that has not yet been partially or fully treated, such as mechanically, chemically, or thermally in various examples. Biomass as used herein can refer to raw or processed biofuels (including biofuels processed from biomass) in various embodiments. Second and third generation biomass materials and biofuels are also contemplated herein in various uses although the present description may not recite applicability of second and third generation biomass materials and products produced therefrom in each embodiment herein.

According to the present disclosure, microwave energy can be utilized, alone or in combination with other processes or energy sources, for thermal processing and treatment (or pre-treatment) of biomass material. Some examples of thermal treatment of biomass material can be referred to as thermal conversion of biomass. Thermal conversion processes use heat to transform biomass material into a more practical and economically-viable fuel, such as liquid, solid, or gaseous fuels. Notably, thermal conversion is distinct from actual combustion of biomass material for use as a thermal energy source, although both options among others are contemplated herein. Thermal processing, e.g., conversion, of biomass material typically includes various thermal processes known as torrefaction, pyrolysis (including fast, slow, ablative, vacuum, fluid bed reactors, entrained flow reactors, rotating cone reactors, and the like), and gasification. These thermal processes are each defined by the extent to which the thermally-induced chemical reactions involved are allowed to proceed, the temperatures during the processing, and whether and how much oxygen is available during the process. Also contemplated are various hydrothermal processes, such as hydrothermal upgrading. Applicant hereby incorporates by reference in its entirety the web page with URL: https://www.bioenergyconsult.com/tag/thermal-treatment-of-biomass/, and entitled “Thermal Conversion of Biomass” and “Torrefaction of Biomass: An Overview” authored by Salman Zafar, and published Sep. 24, 2021, and Sep. 7, 2020, respectively, for all purposes herein. Both were accessed on Oct. 19, 2021. Biomass material can be combusted and/or co-fired (e.g., with coal) in various examples, usually at a final heating or combustion site.

Various processes can be used for high moisture content biomass, including aqueous slurries, and which allow these high-moisture (e.g., wet) biomass materials to be converted into more convenient, economical, transportable, and usable forms. For example, moisture content, and thus weight, of the high-moisture biomass can be reduced, resulting in low-moisture (e.g., dry) biomass, e.g., that contains less than 50% water by weight and/or by volume.

Other embodiments contemplated herein utilize thermal processing of biomass material in combination with any of chemical, biochemical, and/or electrochemical conversion and/or treatment. In general, it can be more energy efficient to combust solid biomass rather than combusting liquid-based biofuels because more of a raw biomass can be utilized. For example, for a given amount of raw corn, a greater amount of energy can be extracted from the solid corn products during combustion, than a related quantity of ethanol biofuel derived from the given amount of raw corn.

Biomass materials, such as various biomass waste materials, can be received for processing before thermal processing (or in some cases after prior processing step(s)). Processing of biomass material as contemplated herein includes heating an extracted biomass-based material or composition, to a desired state, form, temperature, density, consistency, water content, and/or physical, biological, or chemical composition, or to achieve any number or type of desired biomass properties, using microwave energy while continuously moving the material during heating.

As disclosed herein, microwave energy preferably provides energy for thermal processing, treatment, pre-treatment, or other heating of biomass and related materials. Thermal treatment of biomass material often can improve the viability of biomass, especially at scale and over large geographic areas. Thermal treatment or conversion of biomass, especially microwave-based thermal treatment, as contemplated herein includes any of: pyrolysis, gasification, and torrefaction, liquefaction, compaction, homogenization (including at least partial equalization of energetic homogeneity, chemically and/or mechanically), densification (chemically and/or mechanically, such including improving energy density by pelletization or briquetting), volume reduction, etc. of the material. Various methods of liquefaction, including indirect and direct liquefaction; such as thermodynamic liquefaction, including pyrolysis liquefaction and hydrothermal liquefaction, are also contemplated herein. Thermo-catalytic treatment, fermentation, distillation, Fischer-Tropsch and related processing, of biomass material using microwave energy (e.g., as a reaction mechanism) are also contemplated herein.

Various embodiments contemplate various biomass material processing steps, including steps (including treatment and pre-treatment steps) resulting in bio-oil, such as described in Zhang et al. “Liquefaction of Biomass and Upgrading of Bio-Oil: A Review” 2019, Molecules 2019, MPDI, which is hereby incorporated herein by reference for all purposes. In some embodiments, both biochar and bio-oil can result from processing. Various microwave-heating embodiments herein can be used in conjunction with the descriptions as in Zhang as applicable. In various embodiments, liquefaction using microwave energy can include slow pyrolysis, fast pyrolysis, flash pyrolysis, vacuum pyrolysis, and combinations thereof.

Various mechanical processes contemplated herein can be performed before, during, and/or after various microwave heating steps. Post-processed, and resulting biomass can have higher (energy) density, contain less moisture, and are more stable in storage than the original, raw, loose, and/or waste biomass material from which the resulting biomass product (post-processed) is derived. Thermal treatment of biomass in various embodiments can alternatively or further provide for sterilization, elimination of pathogens, or other heat-based treatment to make biomass free of or have a substantial reduction of various undesirable microbial, pathogen matter, and/or the like. Various post-treatment biomass materials can be referred to as biomass products (or products derived therefrom) suitable for reuse, resale, consumption, and/or combustion, among other uses.

Embodiments, improvements, and variations to biomass processing and treatment are discussed herein. In particular as disclosed herein, microwave-based heating using conveyor units and/or microwave suppression tunnels can be utilized and bolstered by one or more fluidized bed reactors or aspects thereof

Various methods and systems can be used to form briquettes, pellets, and the like from treated biomass material, e.g., after microwave thermal processing and treatment. Pelletizing is a compacting process in which finely ground biomass is converted into a homogenous dense fuel in cylindrical shape with free-flowing properties. A pellet generally has uniform product characteristics in terms of size (e.g., length and diameter of 13-19 mm and 6.3-6.4 mm, respectively), shape (e.g., cylindrical), and unit densities (e.g., 1,125-1,190 kg/m³). A pellet mill can be used for form pellets from a flowable biomass stock, and the pellet mill can include a perforated hard-steel die with one or two rollers. As the die and rollers operate, the feedstock can be extruded through the die due to both roller pressure and die temperature, forming densified pellets.

Briquettes are usually produced using hydraulic and mechanical presses. Briquettes typically have a density of 800-1200 kg/m³, compared to 60-180 kg/m³ for loose (e.g., not compressed) biomass material. Compared to pellets, biomass briquettes can be made using larger particle sizes and higher moisture content, and at lower specific energy consumption. However, briquettes typically have lower mechanical strength. Various other briquetting technologies are also contemplated, like roller presses, other presses, tabletizers, and cubers, etc., which can be used for densifying the biomass for various applications. Applicant hereby incorporates by reference “Formulation, Pretreatment, and Densification Options to Improve Biomass Specifications for Co-Firing High Percentages with Coal” authored by Jaya Shankar Tumuluru, J. Richard Hess, Richard D. Boardman, Christopher T. Wright, and Tyler L. Westover, Industrial Biotechnology, Vol. 8, No. 3 (2012), URL: https://doi.org/10.1089/ind.2012.0004 accessed Oct. 8, 2021. Applicant also hereby incorporates by reference “The impact of heat treatment on the components of plant biomass as exemplified by Junniperus sabina and Picea abies” by Drygas, Barbara, Joanna Depciuch, Czeslaw Puchalski, and Grzegorz Zagula, Econtechmod, 2016. Vol. 5. No. 3, 41-50.

Such pellets or briquettes can then be more efficiently and more sustainably transported to a desired location, including long distances from the biomass source, and with other benefits, such as combustion that is more efficient and economical. Transportation modes contemplated include trucks, ships (including barges), trains, airplanes (including drones), among any other forms of transportation, including those known in the energy industry. Thermal processing of biomass discussed herein also improves homogenization of the consistency of otherwise often inconsistent and heterogeneous raw biomass. The generally heterogeneous composition of biomass makes producing a consistent biomass product challenging. For example, the diversity of compounds that make up plant cells means the production of biofuel with a consistent heating value is difficult to achieve. Thermal pre-treatment can substantially help to overcome both density and homogeneity limitations by reducing volume, increasing energy density, and improving energetic homogeneity.

For contemplated gasification processes, target qualities, quantity, and/or moisture content of the processed biomass can be specified, among other characteristics. In general, and for resulting post-thermal-processing biomass products, the less variation in the above, the lower the investment and operational cost. Thermal pre-treatment, especially energy densification, is often an important prerequisite for the transport of biomass materials and the viability of various biomass applications. Applicant hereby incorporated by reference in their entireties the following respective references for all purposes herein: “Thermal Pre-treatment of Biomass for Large-scale Applications” IEA Bioenergy: ExCo: 2011:05, Summary and Conclusions from the IEA Bioenergy ExCo66 Workshop; and “Impact of Thermal Pretreatment Temperatures on Woody Biomass Chemical Composition, Physical Properties, and Microstructure,” authored by Ping Wang and Bret H. Howard, MDPA (2017).

Various biomass materials for processing (and/or after processing) can be flowable, or partially flowable, whether in liquid or solid form, including dust or very small particles. Comminution or other mechanical processing of biomass materials can further make materials relatively more flowable (e.g., smaller particle or chunk size of the material) as desired.

Certain contemplated alternative configurations use a “batch” style heating and processing system. In batch systems, a quantity of material is heated and/or mixed together as a single stage and then is dispensed. It is often desirable to have more flexibility than a batch-style heating system affords because flexible operation of the heating and/or mixing system is preferred. Therefore, continuous type heating and/or mixing systems can be preferable because they can provide greater efficiency, control, and flexible scalability and operation, among other benefits. Also disclosed and contemplated are batch-type systems for heating biomass materials, which can also be used with or include thermal processing, pelletization, briquetting, bio-oil production, and other chemical and/or mechanical processing.

More generally, challenges also exist relating to microwave emissions escaping a biomass material processing and heating system. At high biomass material flow rates in a continuous microwave material processing system, microwave energy leakage can be particularly undesirable and challenging.

Another common complication relates to rapid distribution and deployment of heating apparatuses to remote or non-grid-connected regions or situations. Microwave-based heating is generally more portable than other types of heating apparatuses and allows for portable generator use to power the microwave heating units (e.g., microwave generators) and systems if grid power is not readily accessible. Some examples of situations where grid power is not available include rural or remote areas, or other areas that have temporarily lost a grid power connection. Some biomass processing sites may be located at a distance from any grid power connections.

According to the present disclosure, portable, modular, parallel, and/or sequential heating and/or processing conveyor units can provide a modular, scalable, and portable system for heating biomass materials even in remote, or otherwise off-grid biomass material processing locations, e.g., near farms, forests, other natural sources of biomass, and the like. In some embodiments, sharing of portable biomass material processing systems between multiple biomass sourcing locations and/or processing facilities is also contemplated. Stationary, semi-permanent, and permanent embodiments are also contemplated. Various mechanical processing apparatuses and/or lifting conveyors can also be used in-line at any location with the conveyor units as suitable. Packaging various operative components within or attached to containers or other housings, such as shipping containers, can further simplify and streamline rapid and simple distribution, setup, and operation.

Further, various microwave suppression systems and features, such as included in or related to inlet/outlet tunnels can be sized to accommodate the size of the flow of whatever received raw, loose, or other biomass material to be processed (e.g., heated). Crushing, comminution, screening, filtering, sorting, blending, mixing, mechanically homogenizing, and the like are also contemplated and can be performed before or after receiving materials at the processing system. As discussed above, various mechanical compression, processing, and post-treatment processing steps relating to, e.g., pelletization/briquetting are also contemplated, especially as a final step of biomass material processing.

In some embodiments, a microwave heating system of the present disclosure can be configured to process/heat about 100 U.S. tons (90.7 metric tons) of received biomass material per hour or more according to various specifications and standards, although the process could be scaled to accommodate quantities of less than 100 U.S. tons (90.7 metric tons) of biomass material per hour and reach target specifications. For example, certain types of biomass material (e.g., wet biomass) can comprise a greater amount of moisture than other types of biomass material (e.g., dry biomass). A rated capacity of a system can be configured based on an end goal of a particular facility and/or site. For instance, one goal may be to assist material processing by drying, densifying, homogenizing, and/or chemically altering the various biomass materials according to desired and known specifications. These specifications may therefore require less energy and allow for higher throughput than certain other specifications. It is known that various biomass material substances can react differently to microwave heating. Some materials readily absorb microwave energy and heat, and others less so. Some substances are more susceptible to pulsed or varied intensity of microwave energy received. Throughputs and configurations can be determined based on end goals and targeted specification of a user or entity.

In order to reduce microwave leakage from a processing system, one or more microwave suppression systems (e.g., tunnels or chutes) comprising one or more (e.g., flexible and/or movable) microwave-blocking fabric and/or mesh flaps can be used at one or more openings within a microwave-based heating system in order to reduce microwave emissions that would otherwise reach the outside of the microwave heating system. Each microwave suppression system can comprise a flap or series of flaps that are capable of and configured to cover one or more inlets and/or exits from a microwave heating system. The microwave suppression systems can prevent or suppress the escape of microwave emissions from the biomass material heating system. Therefore, one or more of the microwave-blocking fabric and/or mesh flaps can be positioned at outlets and/or inlets of the continuous microwave material heating system.

Each flap can be generally shaped to conform to a shape of a corresponding suppression tunnel, chute, or the like. Outlets and/or inlets of the continuous microwave heating system can include one or more suppression tunnels. In particular, optionally moisture-laden biomass material can be allowed to enter into the heating region of microwave heating while microwaves are simultaneously substantially prevented from escaping a heating trough via the suppression tunnels within the system. As multiple modular heating and processing conveyor units (e.g., including augers) can be arranged sequentially and/or in parallel, various material inlets and outlets are particularly suitable for microwave suppression systems, including tunnels and other related features. In preferable embodiments, separate suppression systems such as tunnels are supplied and connected to both an inlet and an outlet of a system. In other embodiments, additional suppression tunnels or related features can be included intermediately within a biomass material flow path or otherwise to the system such that more than two such suppression systems are included in order to maximize microwave suppression from any number of openings in the system.

It is known that microwave energy is particularly efficient for heating water (e.g., water molecules), which leads to efficient microwave heating of biomass materials that include at least some of such water molecules. Wet biomass materials (including slurries) in some embodiments disclosed in this disclosure can contain more than 50% water (e.g., wet biomass), although embodiments containing less than 50% (e.g., dry biomass) are also contemplated herein. Water can escape a biomass material in the gaseous form of steam when the water is heated to its boiling point (e.g., about 212 degrees Fahrenheit (° F.) or 100° C.). Steam can escape from a heating system through natural convective ventilation, and in some cases by forced ventilation, through positive or negative pressure applied to the system (e.g., an air blower or fan to expedite or assist ventilation). Vents can also be added to improve ventilation and facilitate steam escape characteristics. However, excessive quantities of water can have a negative effect on heating biomass materials. Furthermore, heat exchangers can be used to reclaim heat released as steam (or otherwise) during microwave heating processes, and in particular heat that is emitted from the phase change (e.g., boiling) of water when the biomass material containing at least some water is heated.

Heating a quantity of biomass material to a temperature above the boiling point of water (about 212° F. or 100° C.) can therefore be less efficient because the water particles boil off and escape as steam. During the heating of various biomass materials to certain temperatures, e.g., at or above a boiling point of water, the water that the microwaves can easily heat through molecular oscillation can decrease. Heating of the biomass material then becomes reliant on the microwaves' oscillation of materials other than water and require more energy. A phase change of liquid water to gaseous steam can occur around 180-212° F. (82-100° C.) depending on air pressure or vacuum, and it can be desirable to heat a material, e.g., a biomass material, to any temperature such that the biomass material reaches a temperature (and optionally for a certain time) such that, e.g., a chemical reaction, such as pyrolysis, gasification, torrefaction, liquefaction, etc. of the biomass material occurs, according to various embodiments. In various embodiments, the temperature to which the biomass material is to be heated at least partially causes the biomass material to undergo a chemical reaction, chemical treatment, drying, or thermal conversion.

Steam that is produced from the heating can escape the heating system via vents once the phase change occurs. According to various embodiments contemplated in this disclosure, steam and/or other heat produced and/or emitted during microwave heating can be captured for re-use using one or more air-air, and air-liquid heat exchangers or the like. The steam can exit the system by natural and/or forced ventilation. In some embodiments a carbon scrubber or other filtration or emission capture system can be implemented that is configured to trap or scrub emitted steam, vapor, particulates, and/or odors that result from biomass material processing. In various embodiments, carbon scrubber technology can be used in combination with one or more condensate units.

According to various embodiments the biomass material to be heated and/or processed is a raw, loose, pre-processed, or other otherwise biomass material. In certain embodiments the biomass material can comprise various particles, such as particles to be heated.

The biomass material, e.g., raw biomass material, can have an initial, first maximum particle or chunk size or hardness. The initial, first particle or chunk size or hardness can be reduced to a second, smaller size by a component or feature of or operatively coupled to at least one of the first and second conveyor units, such as a mechanical processing apparatus, or baffle as described herein. Any other suitable mechanical processing apparatus or component for reducing particle size, such as a screen, filter, sorter, separator, shredder, mixer, mesh, brush, mill, press, or the like is also optionally included. If present, the mechanical processing apparatus can be separate from the first and second conveyor units. Sensed torque load on a motor in a conveyor unit can be used as a proxy for hardness, viscosity, density, type, mix, composition, and/or size of biomass materials being processed.

According to various embodiments, and as discussed above, the biomass material typically contains at least some water. As discussed herein, in at least some embodiments, one heat exchanger apparatus configured to recover a heat byproduct from the biomass material. In some embodiments the heat byproduct is recovered from the steam resulting from a heating of the water within the biomass material.

In some embodiments, one or more additives, such as water, can be added to biomass material to be heated and at various stages before, during, and/or after processing. For example, additives can increase or alter microwave energy absorption and efficiency during heating processes or can reduce odor or other material processing emissions. In other examples, additives can be added to biomass materials before processing, in various quantities, and for various periods of time, such as a soaking or steeping period. As discussed above, water or other liquid can be added to a heated biomass material during or after a microwave heating process. This added liquid can affect a constitution of the biomass, e.g., forming a slurry, or can otherwise change microwave absorption qualities, consistency, flowability, viscosity, density, and the like.

In some embodiments, a continuous microwave heating process can include ramp-up time, hold time, process time (e.g., based on time and temperature of processing), and various heating peaks. Mixing of biomass materials of differing physical properties can affect performance during microwave heating, and in some cases affect output processed biomass product (e.g., bio-oil, pellets, briquettes, dust, and the like) qualities, such as homogeneity and energy density, according to some embodiments.

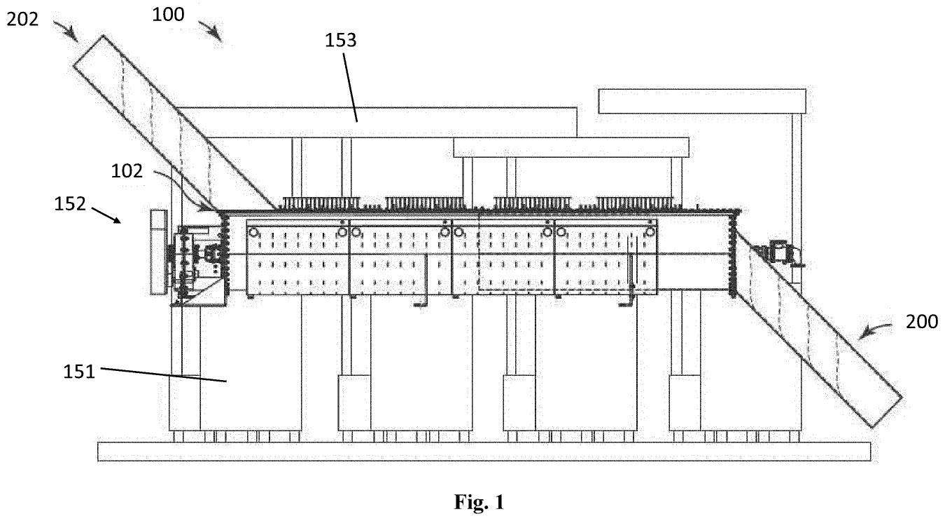

A continuous microwave heating system can be sized in order to get a desired biomass material processing throughput and to accommodate the physical size of the received biomass material being processed. This can be due to limitations, such as with existing heating, mixing, and tunnel design in view of target processing specifications as described herein. An example of (e.g., steel) mesh or fabric flap design of a microwave outlet suppression tunnel 200, as shown in FIG. 1, is better suited for high-volume continuous flow of various sized and consistencies of biomass materials (as explained in greater detail below). Microwave outlet suppression tunnel 200 is an embodiment of a microwave suppression system as used herein. Also as shown in FIG. 1, multiple flaps can be used in a single microwave outlet suppression tunnel 200, e.g., four positioned sequentially as shown. Each flap is preferably shaped to conform to a shape of a corresponding outlet suppression tunnel 200, chute, or the like.

Heating, treating, cooling, freezing, wetting, drying/dehydrating, condensing, breaking, shredding, filtering, separation, crushing, milling, sorting, sifting, shaping, lifting, moving, mixing, (partially or fully) combusting, etc. (collectively “processing”) of materials such as biomass materials is contemplated herein, in addition to other mechanical, chemical, thermochemical, physiochemical, biological, and other variations and combinations thereof, including as described above. Processing steps can involve naturally occurring (e.g., freezing) and/or artificial or human-made steps (e.g., microwave heating). However, any one type of suitable biomass material or chunk or clump including one or more materials can be heated, such as any other material that can be heated, and conveyed or flowed through a microwave heating system. For example, biomass material can include any type of organic or similar sourced material as described above. Other applications of the microwave heating of biomass materials are also contemplated. Various applications of microwave-based processing of materials discussed herein are applicable on Earth as well as other celestial bodies (e.g., moons, asteroids, etc.), spacecraft, and/or in space according to various embodiments. As discussed herein, a post-processed (or in some cases at least partially processed) biomass material can be referred to as a biomass product or the like.

One usage of microwave-based processing of various materials, such as biomass materials, is for microwave-assisted pre-treatment, treatment, or conversion. Microwave-based biomass and related applications can reduce energy consumption, e.g., during processing of various biomass materials and can also make producing economically viable and sustainable biomass products that can be stored and transported similar to current energy sources, logistically.

For processing, a biomass material can be heated and therefore processed or treated to a degree based on time and power of a microwave generator. For example, and in various embodiments herein, a quantity of biomass material is heated to at least a first temperature by applying microwave energy to the biomass material, e.g., within a housing of a conveyor unit. In further embodiments, the biomass material is heated to the first temperature for a first time period (e.g., a dwell time) within the first housing. In various embodiments, the first temperature is a temperature of reaction of the biomass material, such as according to various processed described herein, including pyrolysis, torrefaction, gasification, and liquefaction. Various temperatures and times for biomass processing and treatment are disclosed in Zhang, above.

For example, biomass material can be heated to a first temperature of 180° C. for 15 minutes or less in some embodiments using methods and system described herein. In other embodiments, the biomass material can be heated to a lower temperature for a longer period of time, such as 120° C. for approximately 30-90 minutes. In yet further embodiments, the biomass material can be heated to approximately 450-500° C. for a high yield of bio-oil, or in some cases can be heated to 450-600° C. Examples of reaction times of biomass material being heated can range from about 1 minute to about 240 minutes, or any subset thereof using methods and systems described herein. In yet further embodiments, the first temperature can be in a range from 300-360° C. Although certain examples of processing times and temperatures are listed above, it is understood that any temperature and time can be utilized herein according to various biomass material regulations, reaction, standards, and the like. Moreover, in yet further embodiments, reactions of biomass can be monitored during processing, and heating power and conveyor unit movement speed of biomass material being processed can be updated dynamically based on determined actual processing and reaction rates of the biomass material and the like. The first temperature can therefore be predetermined (static) in some embodiments, and can be determined dynamically (not predetermined) or not determined at all in other embodiments. In yet further embodiments, the first temperature is not monitored at all, and reactions themselves in the biomass material are monitored instead.

In further embodiments, the system is configured to process the biomass material continuously, and wherein a processing speed of the system is adjustable such that the speed can be reduced to increase heating, or can be increased to reduce heating of the biomass material being processed within the at least one conveyor unit. Reduced processing speed preferably results in increased heating (dwell) time, and for a given microwave power level, a greater total energy would be applied to the biomass material being processed. Likewise, increasing processing speed preferably results in reduced heating (dwell) time, and less total energy would be applied to the biomass material being processed.

The compositions of biomass being processed also affect various processing characteristics. Approximately 3-200 kW of microwave power can be used in a particular system, but any power level is contemplated according to situation and specifications. Microwaves heat up biomass materials based on various properties, and different portions of different biomass are therefore heated at different levels according to the varying microwave absorptive properties thereof.

Various embodiments of heating and/or processing systems discussed in this disclosure can have various total weight, and/or throughput capacities, depending on dimensions, power capacity, arrangements, and the like. In some embodiments, a continuous biomass material processing system discussed herein has a capacity of about 10-1000 U.S. tons (9.1-907.2 metric tons) of biomass material per hour. In further embodiments, the capacity can be between 50-100 U.S. tons (45.4-90.7 metric tons) of biomass material per hour. Any other capacity of biomass material processing is also contemplated.

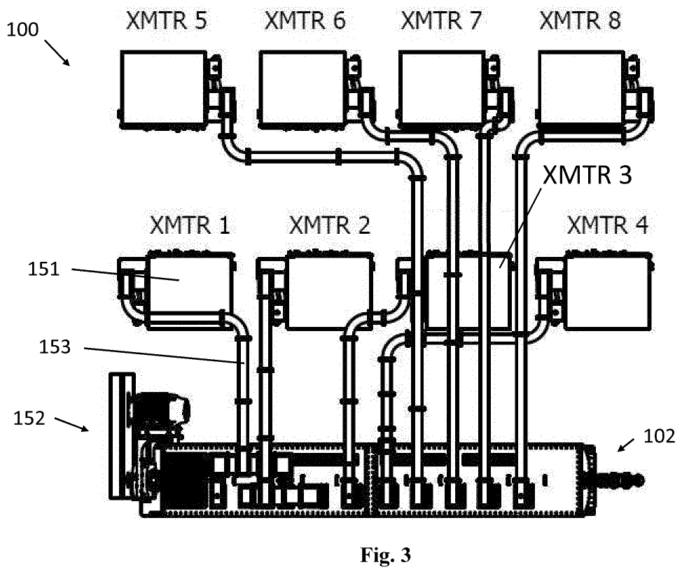

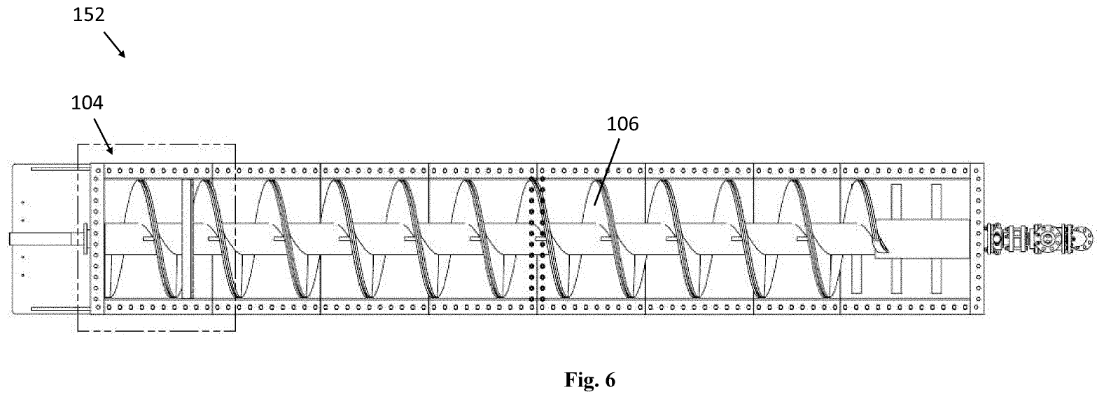

FIGS. 1-9 illustrate an embodiment of a portable, continuous biomass material processing system 100 having a housing, vessel, or trough 102 (as shown in FIGS. 1-5) (or alternative trough 104 as shown in FIGS. 6-9) comprising a microwave heated apparatus with one or more microwave heating units 151 each with at least a corresponding waveguide 153 to define a guide path for microwaves (see e.g., FIGS. 1 and 3). The continuous processing system 100 also preferably includes at least an outlet suppression tunnel 200, as shown. The continuous processing system 100 also includes a housing including a trough 102 including one or more microwave heating units 151, a conveyor system such as including an auger 106, an inlet suppression tunnel 202, and the outlet suppression tunnel 200. These and other contemplated components are described in greater detail herein.

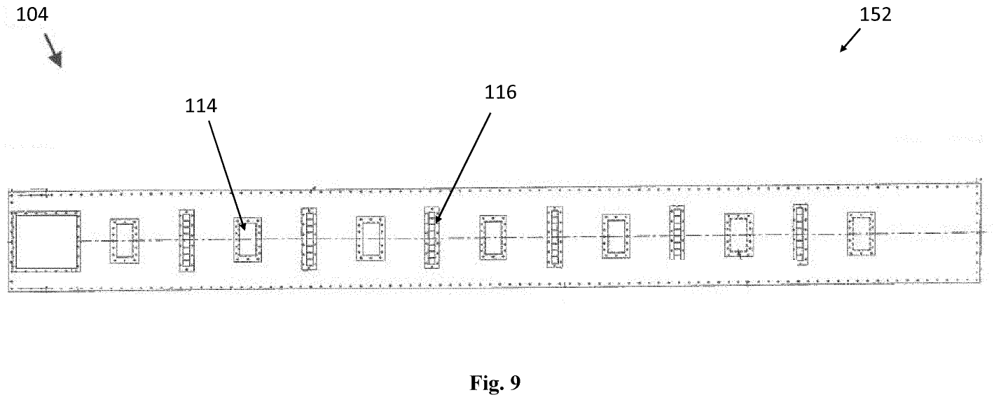

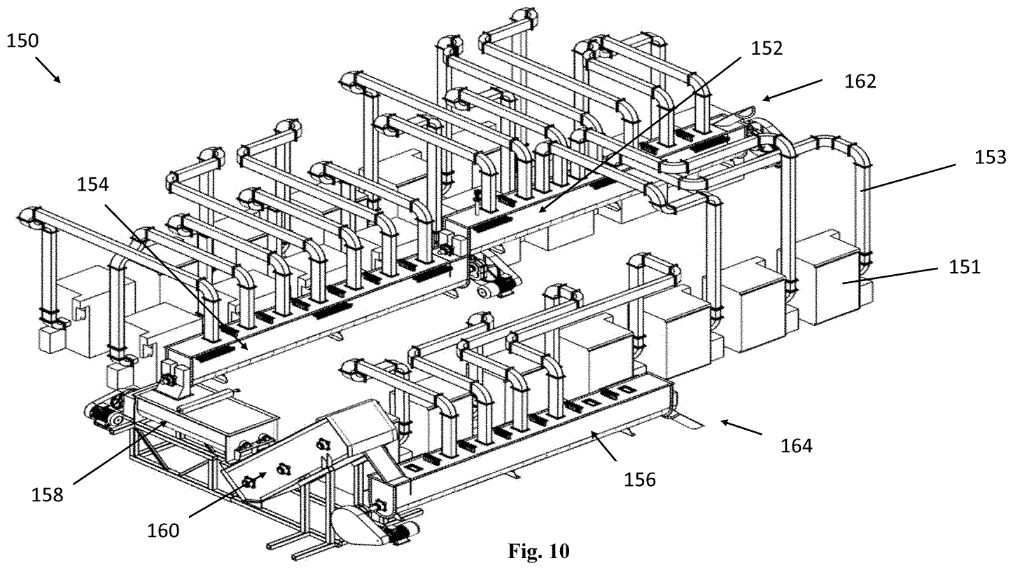

According to FIGS. 1-9 a single conveyor unit continuous biomass material heating and/or processing system 100 is shown, although in various embodiments in this disclosure (e.g., FIGS. 10, 11, and 14) it is also shown that multiple conveyor units can be assembled and arranged sequentially. Conveyor units can therefore be assembled sequentially, but also in parallel, or both in order to achieve a desired throughput for a given conveyor unit size and/or heating capacity; or in order to achieve a desired heating capacity and throughput for a production or processing rate needed to fulfill specification and standards requirements for heating biomass material(s). Arrangements and the like can be adjusted for a given conveyor unit specification by introducing multiples of the conveyor unit and/or arrangements thereof. For example, running two conveyor units in parallel can offer twice the heating capacity and/or throughput of processed material compared to a single conveyor unit, provided suitable microwave heating units are used.

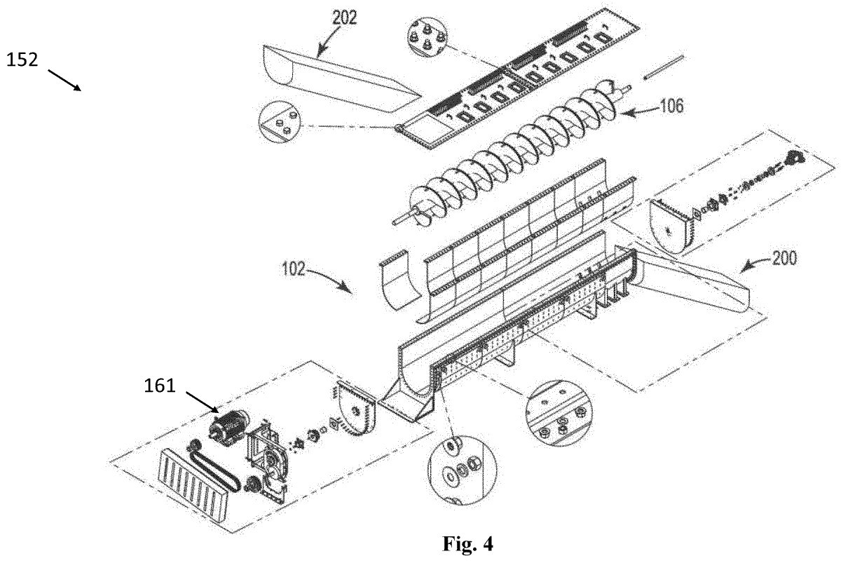

Shown in FIGS. 4, 6, and 8, a helical auger 106 or (e.g., a helical screw) is one option for a conveyance mechanism by which biomass material (e.g., raw and/or loose) particles or chunks can be caused to pass through the housing trough 102 longitudinally. The auger 106 can be completely or partially covered in biomass material particles, clumps, bunches, or chunks to be heated during operation, but the biomass material is not shown for clarity. The auger 106 can be a heated auger, and in some embodiments can be a jacketed auger (e.g., where an auger has a hollow fighting that heating fluid is run through as desired). The outlet suppression tunnel 200 can be connected to an outlet and/or inlet of trough 102. The trough 102 can be level or can be canted at an angle to the horizontal plane according to various embodiments. An angled trough 102 (and/or auger 106 in some embodiments) can facilitate movement of the biomass material during processing by utilizing gravity assistance to flow downhill. A trough 102 can be about twelve feet long and five feet wide, although any suitable size and/or shape is also contemplated.

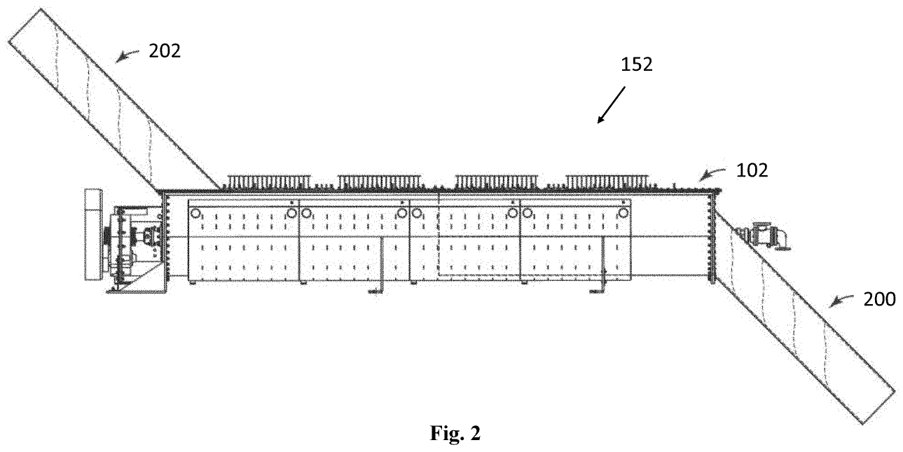

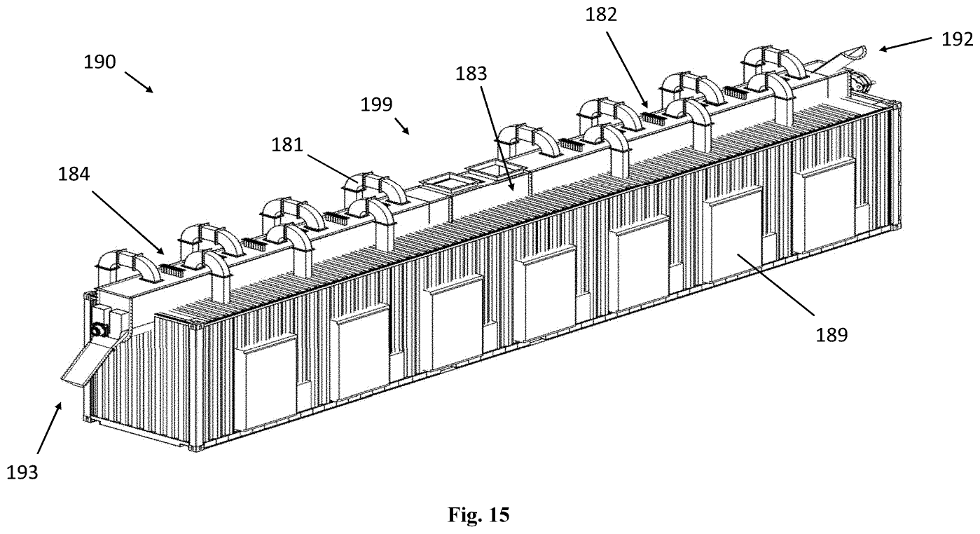

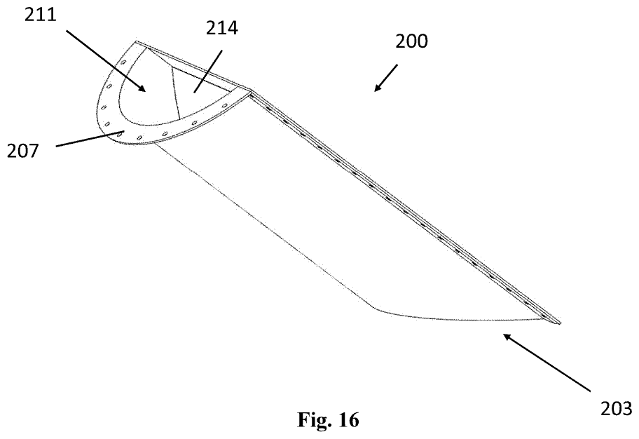

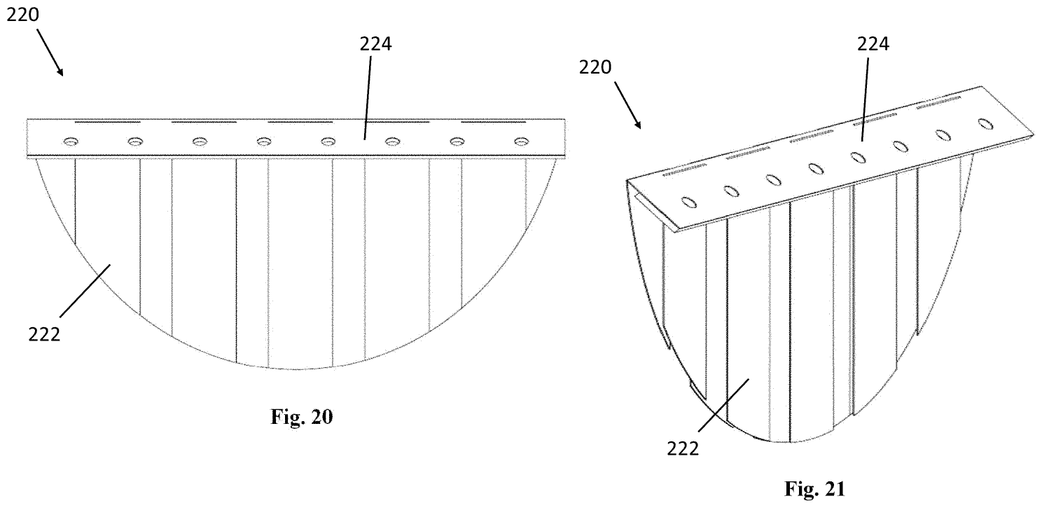

FIGS. 2-9 show various components of the trough 102, auger 106, inlet suppression tunnel 202, outlet suppression tunnel 200, and other components of the system 100 in greater detail. Selected embodiments and variations of the inlet suppression tunnel 202 and the outlet suppression tunnel 200 and components are shown in yet greater detail with respect to FIGS. 16-31. Furthermore, various embodiments of multiple-conveyor microwave-based biomass material heating systems are shown with reference to FIGS. 10-15.

FIG. 3 shows a general configuration of a single-conveyor unit 152, continuous heating system 100 of the present description, including eight microwave heating units 151, a microwave waveguide 153 for each heating unit 151, an auger-based continuous heating assembly with trough 102, and various other components. In particular, FIG. 3 shows an embodiment including eight microwave heating units 151 labeled as XMTR 1, XMTR 2, XMTR 3, XMTR 4, XMTR 5, XMTR 6, XMTR 7, and XMTR 8. More or fewer microwave heating units 151 (and corresponding waveguides 153) can be used in alternative embodiments. A number of waveguides 153 and therefore microwave generators 151 used with a trough 102 can be limited by a surface area on top (or other side) of the trough 102, including any vents, inlets, and/or outlets included thereon. In some embodiments 1-30 waveguides 153 can be utilized for each conveyor unit, and in more specific embodiments 7-10 waveguides can be utilized for each conveyor unit. Optionally, microwave heating disclosed herein can be continuous and/or pulsed or varied according to various material characteristics.

In one embodiment, microwave heating unit 151 can be a microwave power system sourced from Thermax Thermatron. The microwave heating units 151 can have a variety of shapes and sizes according to the requirements of the continuous heating process and system 100. Each microwave heating unit can apply about 100 kW of power to the biomass material being heated and preferably operates at about 915 MHz.

In various embodiments, various quantities of microwave energy can be received by the biomass material while in a conveyor unit. Various conveyor units described in this disclosure (e.g., conveyor unit 152) can have a nominal weight capacity of about 500-40,000 lbs (227-18,144 kg). In some embodiments, the conveyor units can each have a weight capacity of about 8,500 lbs (3,856 kg) of biomass material at a point in time.

Various embodiment waveguide 153 configurations and embodiments for a single conveyor unit 152 are shown in FIGS. 1 and 3. The various waveguides 153 can be configured to bend and be routed such that no two waveguides 153 collide, and in some cases the waveguides can be configured to minimize turns or bends in the waveguides, as practical. Similar waveguide 153 configurations can be adapted for use with multiple-conveyor unit material processing systems described below. Each microwave heating unit 151 can optionally be connected to more than one waveguide 153.

Still referring to FIG. 1, a side view of the continuous heating assembly is shown, including an inlet suppression tunnel 202, outlet suppression tunnel 200, and trough 102 of system 100. Although not shown, the trough 102 can be generally mounted or positioned, or provided with a shape generally comprising an angle relative to horizontal to facilitate biomass material movement or production during heating and/or conveying biomass material for processing described herein, e.g., by at least partially utilizing gravity to move the biomass material through the trough 102. Non-stick coating can be applied to the trough 102, such as to an interior portion of the trough 102 such that biomass material is less prone to get stuck and resist movement during processing.

FIG. 4 is an exploded view of system 100. Shown is a conveyor motor 161 for rotating the auger 106, the housing trough 102 for holding and carrying the biomass material to be heated, the inlet suppression tunnel 202, the outlet suppression tunnel 200, and various other components. The conveyor motor 161 can be an electric, brushed or brushless, induction or permanent magnet, synchronous, asynchronous, variable reluctance motor (as well as other motor types) and can utilize alternating current (AC) or direct current (DC) power of any voltage or power as suitable. Any other suitable type of motor, including an internal combustion engine or gas turbine, can also be implemented. In particular, FIG. 4 provides a more detailed view of system 100, including the trough 102, auger 106, inlet suppression tunnel 202, outlet suppression tunnel 200, and related components.

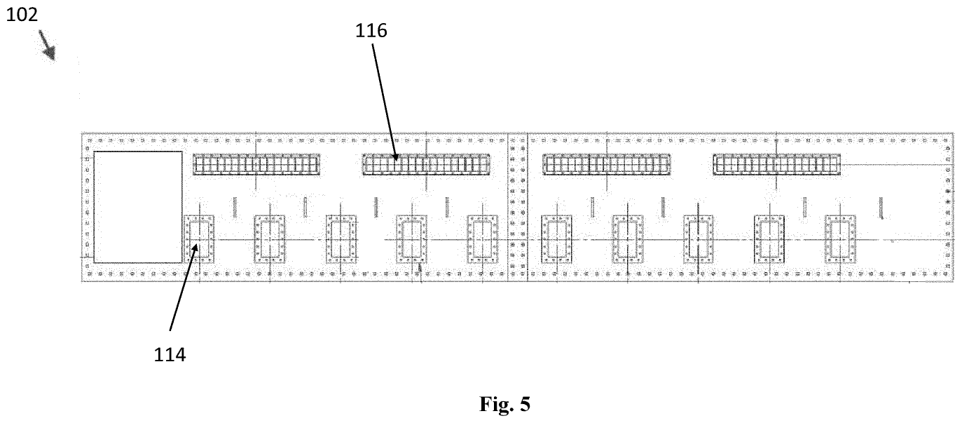

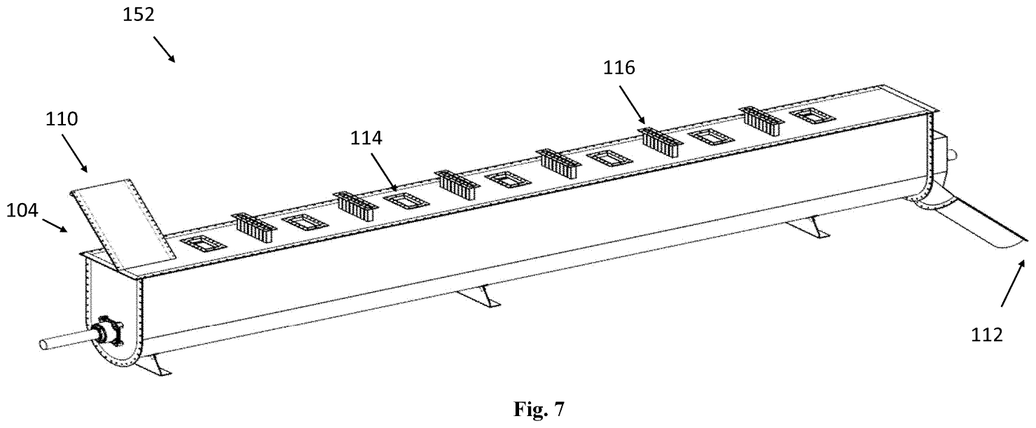

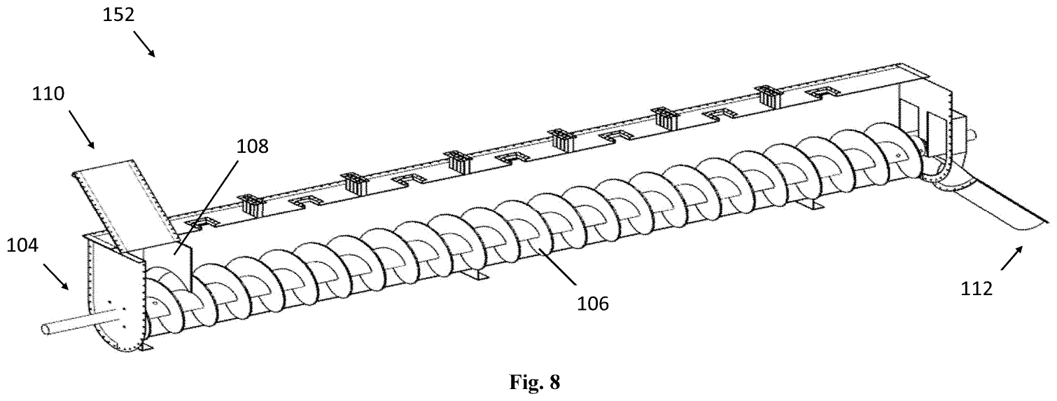

Various entry points for microwaves via the multiple waveguides 153 in a top of trough 102 are shown in FIG. 5. FIG. 9 shows alternative entry points in a top of the alternative trough 104. Various other arrangements and configurations of troughs, conveyor units, and/or systems are also contemplated herein. Waveguides 153 are also referred to as microwave guides herein. As shown in FIGS. 7 and 8, the alternative trough 104 can include a material inlet 110 and a material outlet 112. One or both of inlet 110 and outlet 112 can include a microwave suppression tunnel and/or features as described herein. Various components herein, such as inlet 110 and outlet 112 may not be shown to scale, and various other shapes and configurations are also contemplated.

In the conveyor unit 152 configuration of FIG. 6, the example, alternative trough 104 (or housing) of the continuous heating assembly that includes the auger 106. The auger 106 can optionally be heated and used to cause biomass material, to be heated using liquid and/or microwave heating, to be moved longitudinally along the trough 102 of the conveyor unit 152 during heating, processing, and/or production. The auger 106 can also be caused to rotate directly or indirectly by the conveyor motor 161 (see FIG. 4) (or alternatively, an engine), according to various embodiments. Furthermore, the auger 106 can rotated by conveyor motor 161 either slowly or more quickly according to various parameters, which can be based on need or usage, such as target temperature, microwave heating power, and the like. The motor 161 can have a power rating of 50-150 kW, 70-130 kW, 80-110 kW, or 90-100 kW in various embodiments. Embodiments with the motor having any power rating, including below 50kW or above 150 kW are also contemplated.

As shown the auger 106 can be helical, and in some embodiments the auger 106 can be single helical or double helical, among other variations. In yet further variations, a single trough 104 can comprise two separate augers 106, which can be counter-rotating or otherwise (not shown). As shown, a fluid connection can be attached to one or more ends of the auger 106, which can be used for additional auger-based heating or cooling of biomass material being processed.

FIGS. 7-9 show various views of the alternative configuration 104, where various apertures within the alternative trough 104 cover are instead positioned in alternative locations as compared to trough 102. More specifically, the microwave inlets 114 and vents 116 are generally placed inline as shown with trough 104. Various embodiments that utilize trough 104 can be similar to embodiments that utilize trough 102, and various other configurations are also contemplated herein.

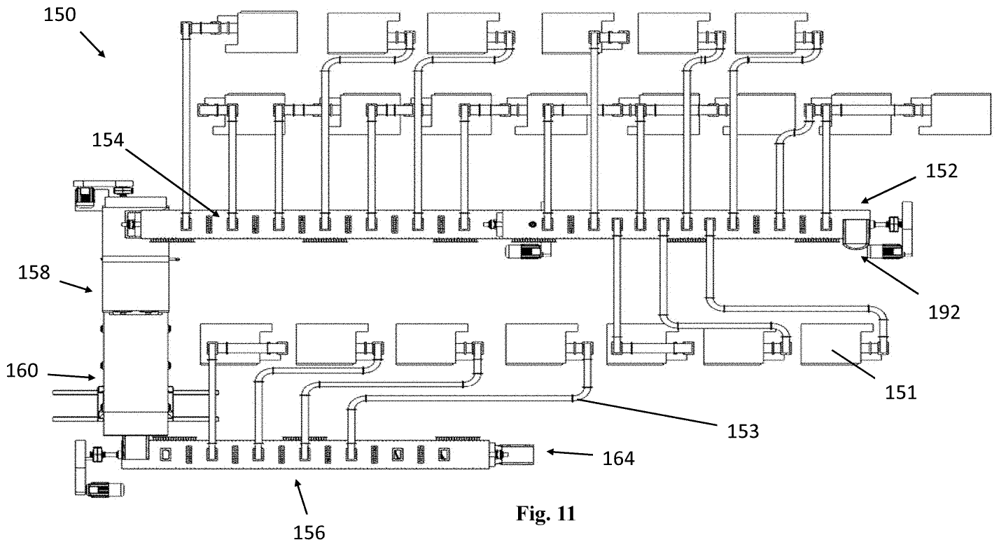

FIGS. 10 and 11 show an embodiment of multi-conveyor continuous biomass material processing system 150. The system 150 as shown comprises three conveyor units similar to conveyor unit 152 described above, in addition to a mechanical processing apparatus 158, lifting conveyor 160, and two microwave suppression tunnels (e.g., 200, 202) shown at inlet 162 and outlet 164. Multiple microwave heating units 151 are also shown connected to the conveyor units via multiple corresponding waveguides 153 as described herein.

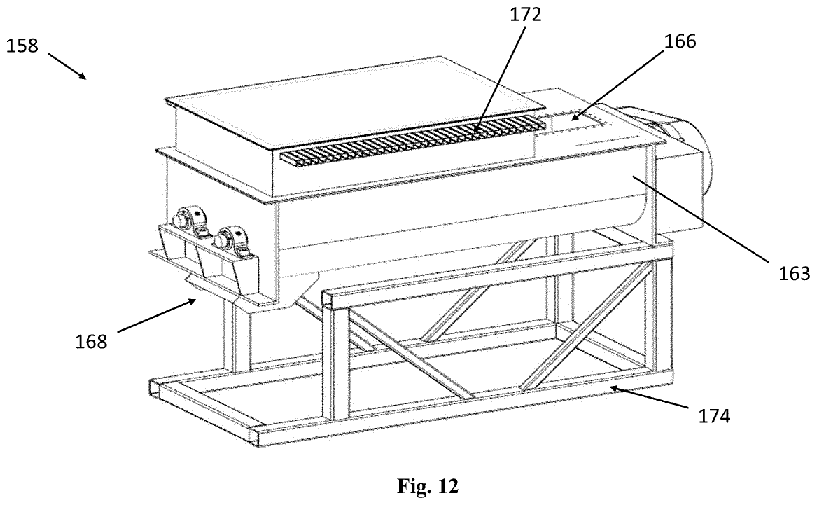

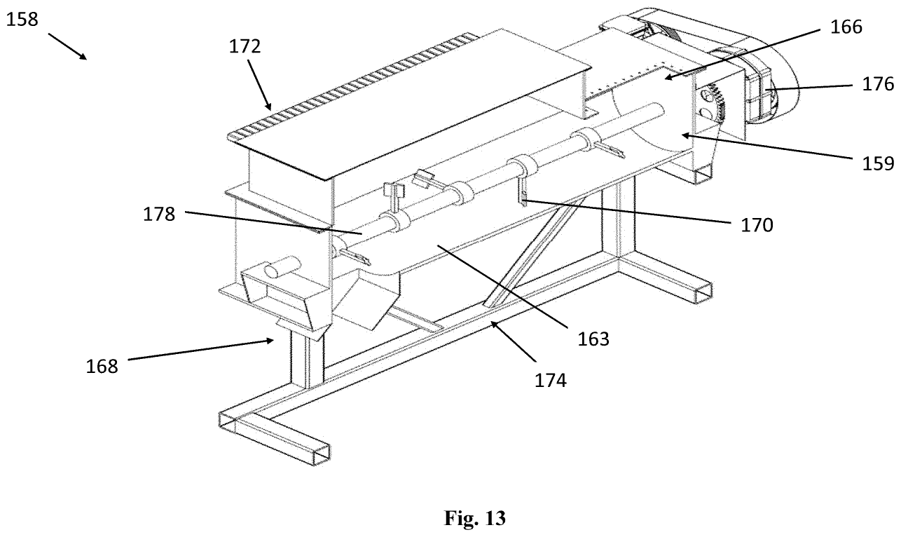

A first conveyor unit 152 receives a quantity of biomass material to be heated, and the system 150 operates sequentially by passing the biomass material to a second conveyor unit 154 following the first conveyor unit 152, and to a third conveyor unit 156 following the second conveyor unit 154. An optional mechanical processing apparatus 158 (described in greater detail with reference to FIGS. 12 and 13), and a lifting conveyor 160 are also shown inline and between the second conveyor unit 154 and the third conveyor 156 in a sequential or serial arrangement. One or more mechanical processing apparatus 158 can preferably be utilized with, or to create, more flowable or slurry type materials. In other optional embodiments, a return system can be implemented where biomass material is returned to the inlet 162 once it has approached or left the outlet 164 or equivalent. In this way, a given system 150 can simulate a larger system and can achieve higher temperatures and/or longer heating times as desired.

In particular, the mechanical processing apparatus 158 can be located sequentially after an outlet of the second conveyor unit 154, and the lifting conveyor 160 can be located sequentially after the mechanical processing apparatus 158 and before the third conveyor unit 156. The mechanical processing apparatus 158 can be any of various mixers, agitators, crushers, mills (e.g., hammer mills, pug mills, etc.), shredders, filters, sorters, and the like, or any other type of suitable mechanical processing apparatus or system as known in the art. The mechanical processing apparatus 158 can also include one or more pellet and/or briquette forming apparatuses as described herein.

As described and shown in this disclosure, any number of conveyor units 152, 154, 156, etc. and any number of mechanical processing apparatuses 158, lifting conveyors 160 can be utilized in various systems such as 150. Moreover, the various components within the system 150 can be arranged in any suitable order according to a desire or need. Furthermore, microwave suppression tunnels (e.g., 200, 202) are preferably utilized at various inlets and/or outlets of the system 150 according to various embodiments.

The various conveyor units 152, 154, 156 can positioned such that the first conveyor unit 152 is vertically elevated and that the second and/or third conveyor units 154, 156 are positioned sequentially lower than the first conveyor unit 152 so as to utilize gravity to facilitate movement of biomass material being heated between the various conveyor units when in use. In some embodiments, one or more lifting conveyor 160 can also be utilized to lift or raise the biomass material being heated and reduce a total amount of height required for various conveyor units. Although not shown, additional lifting conveyors can be used before or after processing of the biomass material, such as to receive materials to be heated, to form a pile of processed materials after processing, and/or to feed processed biomass materials to briquette/pellet forming, bio-oil production apparatuses, or the like (not shown).

When arranged sequentially, the first conveyor unit 152 can heat the flowing or otherwise moving biomass material to a first temperature, the second conveyor unit 154 can heat the material to a second temperature greater than the first temperature, and the third conveyor unit 156 can heat the biomass material to a third temperature that is greater than the second temperature according to various embodiments. Each conveyor unit preferably heats the biomass material using microwave energy as the material flows and such that a third or final desired temperature is reached before the biomass material exits the heating and/or processing system, e.g., after achieving a desired heating and time specification per various regulations. The various conveyors can heat the biomass material to the first temperature for a first amount of time, and similar to the second, third, etc. temperatures. Each temperature can have an associated time therewith, such as to meet certain specifications of heating or an associated chemical reaction. Alternatively, a temperature and/or time can be set variably based on a sensed reaction or state of biomass material being processed, e.g., when a certain state has been achieved regardless of temperature and/or time for processing.

Any conveyor unit, such as the first conveyor unit 152, can further include a baffle 108 (see FIG. 8), preferably a vertical baffle or a baffle that is otherwise at least partially transverse to a direction of material flow within the conveyor unit 152, which is configured to restrict, guide, and shape the biomass material as it proceeds through the first housing of the first conveyor unit 152. For instance, the baffle 108 can assist the auger 106 in restricting the flow of, leveling the biomass material to a desired maximum level within the first conveyor unit 152, or reducing the particle size of received biomass material to a desired diameter or length for processing and/or heating.

In some embodiments, the biomass material to be processed, before or after passing the baffle 108, has a maximum material chunk diameter or size of about eight inches (20.32 cm). In other embodiments the maximum chunk diameter is about six inches (15.2 cm). In yet further embodiments, one or more mill or other mechanical processing apparatus is utilized (as described herein), which can include one or more mill, mixer, impactor, shredder, and/or comminution device, which can be used to reduce a maximum largest dimension of the biomass material chunk and/or produce a denser biomass material during processing. In some embodiments at least some biomass material is crushed, shredded, compressed, or reduced in size within or prior to entering the first conveyor unit 152. Other conveyor units can also include various types of baffles (e.g., baffle 108) or other restrictive or material guiding members or features. In other embodiments, the biomass material is received as a loose, semi-solid, slurry, liquid, or any other at least minimally flowable state. During heating the biomass material can progressively become more solid and less flowable as water is evaporated or boiled off the biomass material, e.g., a slurry of the biomass material. As discussed herein, in optional embodiments, water or other liquid can also be added to the biomass material. In yet further optional embodiments, other substances, such as solvents or sand (e.g., hot sand), can be added to the biomass material for processing at the one or more conveyor units.

FIGS. 12 and 13 show an example of an optional mechanical processing apparatus 158 of system 150 in greater detail. The mechanical processing apparatus 158, e.g., a mixer, generally includes a mixer trough 163 supported by a mixer support structure 174, which can be height-adjustable in various embodiments. The example mechanical processing apparatus 158 also preferably comprises one or more mixer vents 172, and a mixer material inlet 166 and outlet 168. With reference to the cross-sectional view of the mechanical processing apparatus 158 in FIG. 13, the mixer trough 163 has an interior 159 for holding and mixing a material being processed. The mixer trough 163 also supports a mixer shaft 178 (e.g., via one or more bearings, not shown) that is operatively driven by a mixer motor 176. Connected to and protruding from the mixer shaft 178 are one or more mixer axially-mounted paddles 170 that are configured to mix a material held within the interior 159 of the mixer trough 163. Optionally, various heat exchanger components and/or heat recovery components or features can be positioned within or near the mechanical processing apparatus 158. As shown the material is not heated during mixing within mechanical processing apparatus 158. However, in alternative embodiments, the material can be heated while in the mechanical processing apparatus 158. Multiple mixer shafts 178 can optionally be included in mechanical processing apparatus 158.

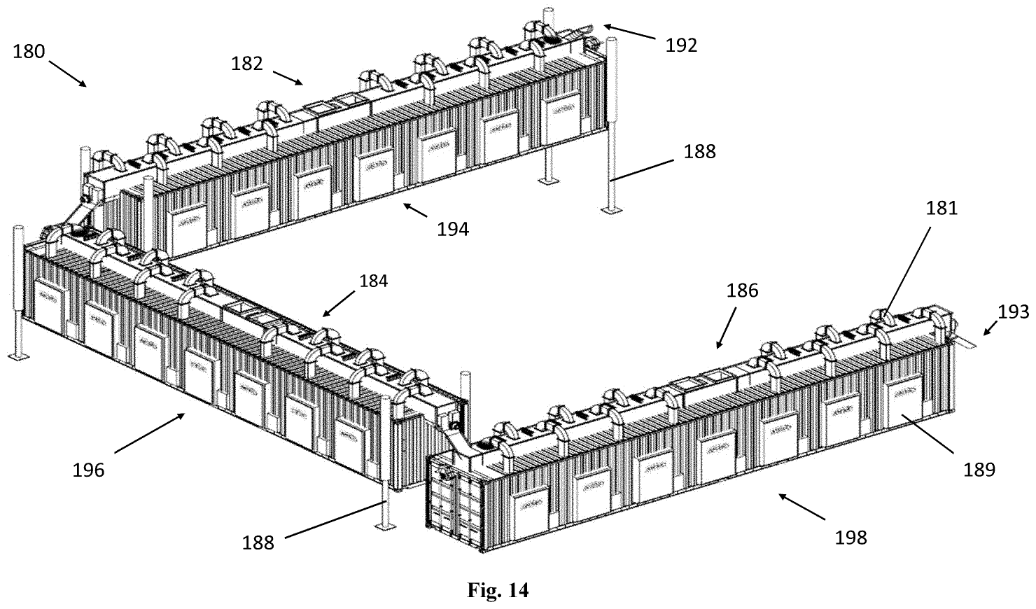

FIGS. 14 and 15 show various mobile multi-conveyor continuous processing systems, including 180 (three conveyor unit) and 190 (two conveyor unit).

Mobile and/or modular multi-conveyor continuous processing systems, such as systems 180 or 190, can be beneficially modular and easily transported. With mobile and/or modular systems, scalability of production can be improved because additional mobile units can be added for a jobsite as needed, provided there is sufficient space, and without having to do any additional fabrication.

As shown in FIG. 14, a three-module, mobile multi-conveyor biomass material processing system 180 is shown. The system 180 as shown is composed of three generally similar mobile container units 194, 196, and 198, each comprising a conveyor unit 182, 184, and 186, respectively. As shown, each mobile container unit also comprises one or more microwave units 189, one or more waveguides 181, and optionally one or more system material inlet 192 and/or outlet 193. According to some embodiments, each mobile container unit 194, 196, and/or 198 is one or more reused or modified industry standard corrugated steel shipping container. Various openings and/or portions can be removed or modified such that the various components can fit onto or within each mobile container unit. The conveyor units 182, 184, 186 are generally positioned above or on an upper portion of the respective mobile container unit 194, 196, 198. The microwave heating or power units 189 are shown as being at least partially integrated into the mobile container units 194, 196, 198, and at least a portion of each microwave heating unit 189 can be exposed to the outside when installed within the mobile container unit.

Each mobile container unit 194, 196, 198 can further be provided with a mechanism for adjusting a vertical position of height of the mobile container unit operative components, such as the conveyor unit. The mechanism can include one or more adjustable height support structures 188, e.g., four with one positioned at each corner of each mobile container unit. The first mobile container unit 194 is positioned at a more raised position, the second mobile container unit 196 is positioned at a less raised position, and the third mobile container unit 198 is positioned at a fully lowered position, e.g., set on a ground or floor without use of the adjustable height support structures 188. Although a mechanical processing apparatus (e.g., 158) or a lifting conveyor (e.g., 160) are not shown in the system 180, in other embodiments one or more mechanical processing apparatuses and/or lifting conveyors can be utilized with the system 180, and can be integrated into one or more mobile container units, such as 194, 196, and/or 198.

FIG. 15 shows an alternative mobile (optionally multi-) conveyor material mechanical processing apparatus and processing system 190 with a single combined mobile container unit 199 with two conveyor units 182, 184 therein. As shown, a single container, such as a shipping container, can be modified to receive two conveyor units 182, 184 in sequence, and optionally can include a mixing and/or venting chamber 183 positioned between the first and second conveyor units 182, 184. Multiple systems 190 can be operated in parallel in order to adjust a throughput of heated biomass material according to a particular need or desire for a mobile operation.

FIGS. 16-31 illustrate various arrangements of features of microwave suppression tunnels or chutes, such as the inlet suppression tunnel 202 or the outlet suppression tunnel 200. As used in this disclosure, the inlet suppression tunnel 202 and the outlet suppression tunnel 200 can be operatively similar and the features of either can be incorporated into the other in various embodiments. Although the inlet suppression tunnel 202 is shown with a single flap 218, multiple flaps 218 can be used in the inlet suppression tunnel 202 among other features of the outlet suppression tunnel 200. Where multiple flaps 218 are used, the flaps 218 can be optionally spaced at about six-inch (15.2 cm) intervals or any other suitable interval.

As shown in FIG. 16, the outlet suppression tunnel 200 can be configured to include one or more microwave absorbing, deflecting, or blocking flaps 214, variously including inlet and outlet suppression tunnel embodiments. Each suppression tunnel can be located attached to or comprised within a material inlet (e.g., inlet suppression tunnel 202) or outlet (e.g., outlet suppression tunnel 200) of various conveyor units as described herein. The outlet suppression tunnel 200 preferably comprises a chute flange 207 for attachment at or near a conveyor unit outlet, or the like. The outlet suppression tunnel 200 can also be configured for use as an “inlet” suppression tunnel with only minor changes, such as changing the location of the chute flange 207, a direction of permitted flap 214 movement relative to the outlet suppression tunnel 200, positioning, and the like. The flap 214 can be a single unit that is movable, flexible, or the like as described below. Flap 214 is attachable and/or pivotably attached to an upper portion of the outlet suppression tunnel 200.

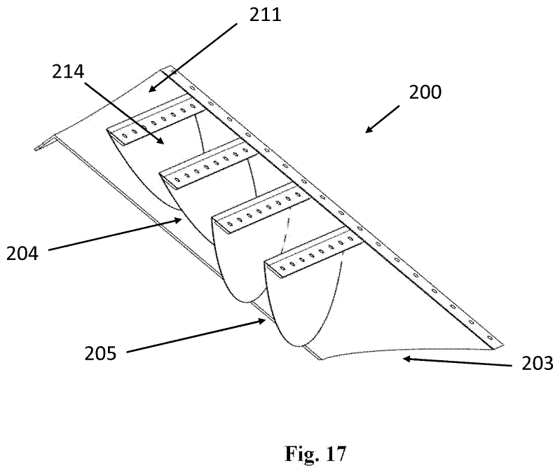

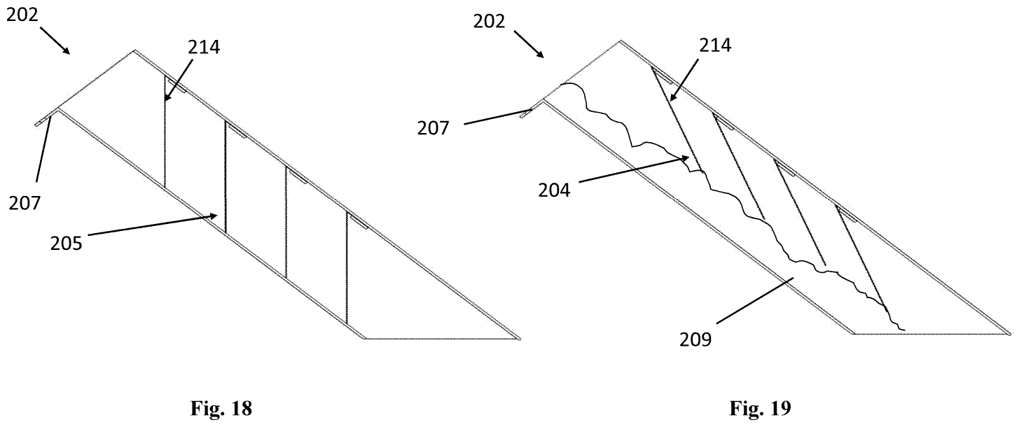

Shown in perspective cross-sectional view in FIG. 17, the outlet suppression tunnel 200 includes flaps 214 that can move from a default, closed position 205 of the flap 214 as it contacts the outlet suppression tunnel 200, to a dynamic, open position 204 as biomass material 209 flows past (see FIG. 19), and applies a pressure on the flap 214, thereby opening it until the biomass material 209 stops flowing or is cleared from the outlet suppression tunnel 200 (see FIG. 18). The outlet suppression tunnel 200 as shown in FIGS. 16 and 17 includes an attachment side, tunnel inlet 211, and an exit side, tunnel outlet 203.

An alternative embodiment of a flap 220 for use herein, is instead composed of multiple sub-portions 222, such as strips of microwave blocking, deflecting, or absorbing material, which are attached to an attachment flange 224 of the flap, which is usable for attachment (e.g., pivotable attachment) of flap 220 to an upper portion of the suppression tunnel 220. In yet further alternative embodiments of suppression flaps, chains, combinations of materials, or any other suitable microwave-suppression composition can be utilized.

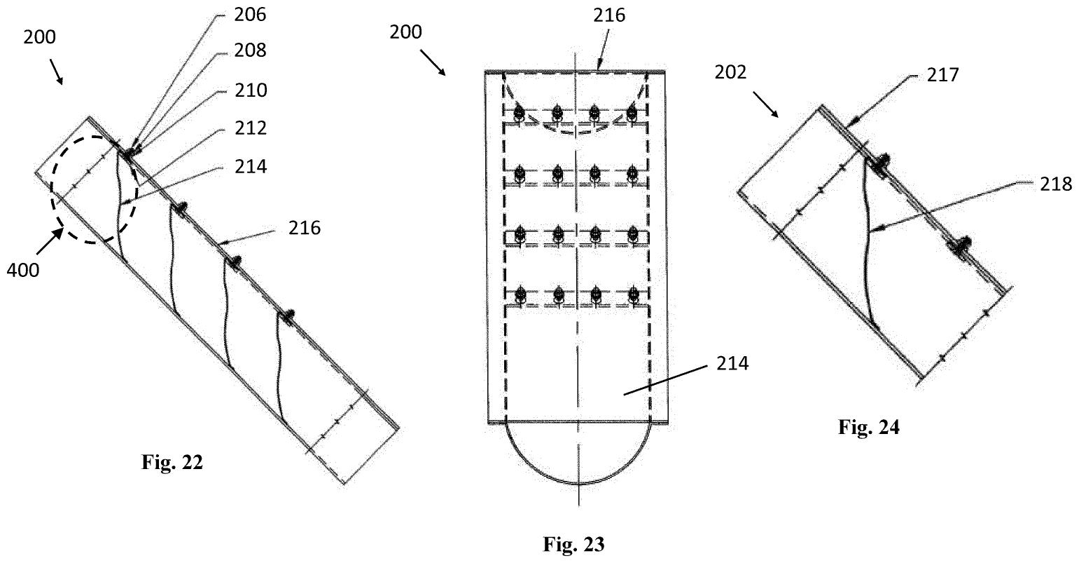

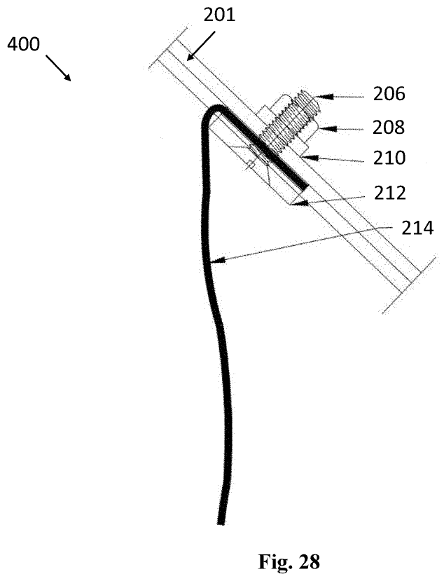

FIG. 22 is a cross-sectional side view of a U-shaped outlet suppression tunnel 200 of an outlet side. As shown, a series of four, single-ply (e.g., single layer) microwave suppression flaps 214 are shown in the outlet suppression tunnel 200 in a down position. At hardware detail section 400 of FIG. 28, flaps 214 can be attached to a top outlet side portion 216 of the outlet suppression tunnel 200 along with attachment hardware including bolt fastener 206, nut 208, bolt washer 210, metal bracket 212, and shielding mesh flap 214.

FIG. 23 is a cross-sectional top view of the outlet U-shaped microwave outlet suppression tunnel 200 of FIG. 22. As shown, multiple attachment points (e.g., using hardware shown at FIG. 28) for each flap 214 are contemplated, although any suitable attachment or arrangement for the flap 214 is also contemplated herein.

FIG. 24 is a cross-sectional side view of a U-shaped inlet microwave suppression tunnel 202 for use with or connection to an inlet side of a conveyor unit, such as conveyor unit 152 of the system 100. System 100 described above with reference in particular to FIGS. 1-4 can have inlet and outlet ends of a continuous motion biomass material pathway (e.g., motivated by auger 106 or other conveyance mechanism of the conveyor unit 152), an inlet suppression tunnel 202 can be used with or without an outlet suppression tunnel 200 as shown in FIGS. 22 and 23. A single, single-ply (e.g. single layer) microwave suppression flap 218 is shown in FIG. 24 attached to a top inlet side portion 217, e.g., using hardware as shown and described with respect to FIG. 28, below. As shown in the embodiments of FIGS. 22-24, the outlet/inlet suppression tunnels 200 and 202 use a single-ply (e.g., single layer) microwave-absorbing, deflecting, or blocking mesh flap 214 or 218, respectively. With reference to mesh flaps 214 and 218 and the like, the term “absorbing” is understood generally to optionally include any of absorbing, deflecting, blocking, and/or any other suppression technique of microwaves.

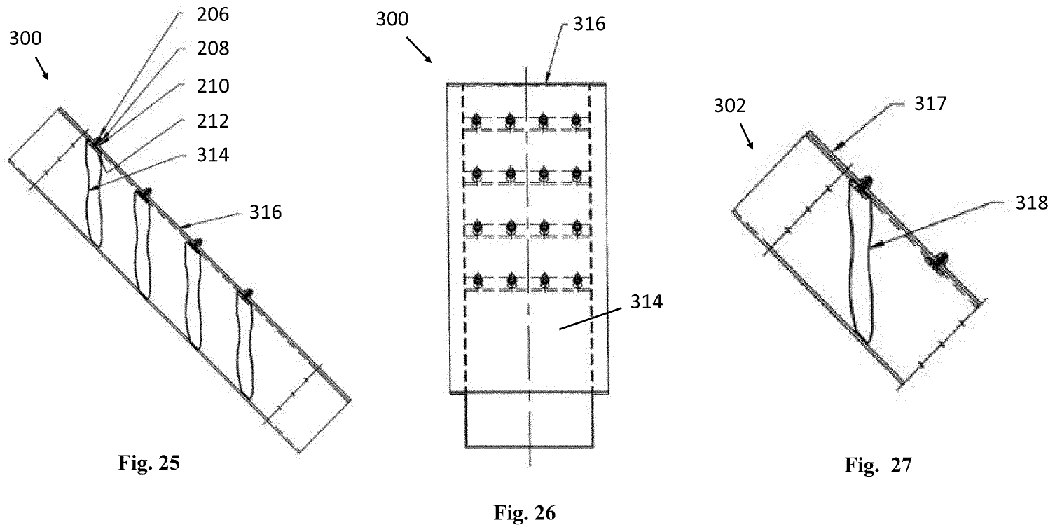

FIGS. 25-27 illustrate alternative embodiments where mesh flap(s) 314, 318 are doubled over as two-ply for increased microwave absorption. FIGS. 25-27 are similar to FIGS. 22-24, respectively, with the exception of the folded over, two-ply (two layer) mesh flap(s) 314, 318.

FIG. 25 is a cross-sectional side view of a rectangular microwave outlet suppression tunnel 300. Four flaps 314 are shown, and each flap 314 can be attached to a top portion 316 of the outlet suppression tunnel 300 along with attachment hardware including bolt fastener 206, nut 208, bolt washer 210, metal bracket 212, and shielding mesh flap 314.

FIG. 26 is a cross-sectional top view of the rectangular microwave outlet suppression tunnel 300 of FIG. 25. FIG. 27 is a cross-sectional side view of a corresponding rectangular microwave inlet suppression tunnel 302. Folded flap 318 is attached to top outlet side 317.

FIG. 28 shows greater detail of hardware detail section 400 of FIG. 22. As shown, a flap 214 can be attached to (e.g., a top inlet or outlet side portion of) a suppression tunnel along with attachment hardware including bolt fastener 206, nut 208, bolt washer 210, metal bracket 212, and shielding mesh flap 214. FIG. 28 shows a side view of a non-looped, single-ply microwave absorbing, deflecting, or blocking flap 214 with a microwave-absorbing, deflecting, or blocking mesh described in greater detail in this disclosure that is attached to an upper portion of a suppression tunnel (or chute thereof, etc.). Only one fastening arrangement is shown at hardware detail section 400, but other arrangements are contemplated. In other embodiments, the flap 214 with mesh can be looped, causing a two-ply (e.g., two layer) flap to be attached at two ends in a manner similar to the fastening arrangement shown at hardware detail section 400.

Flap 214 as shown in FIG. 28 (and any other embodiments of flaps herein) is preferably electrically grounded to a heating system frame 201. The heating system frame 201 is preferably grounded to a power source electrical grid (not shown) according to various embodiments.

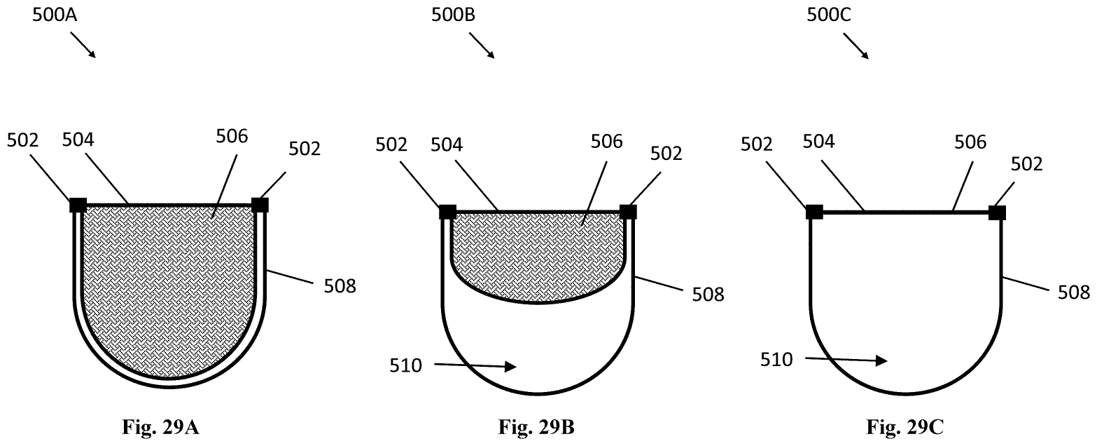

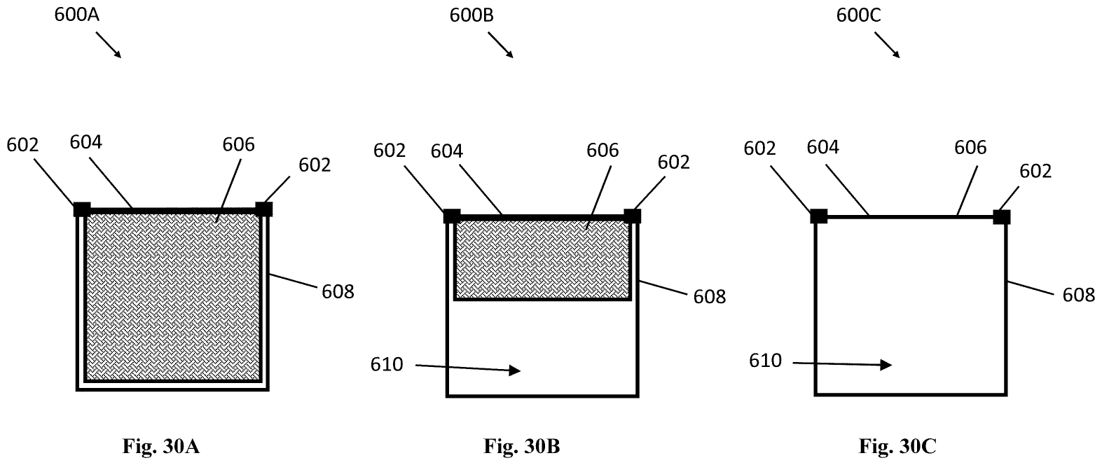

Turning now to FIGS. 29A-29C and 30A-30C, various cross-sectional end views are shown that provide detail of flap configuration within a suppression tunnel or chute in addition to flap articulation or flexing that occurs during continuous biomass material production and movement along the tunnel.

Inlet and/or outlet microwave suppression tunnels (e.g., 202, 200, etc.) can be positioned and connected relative to the continuous heating assembly or system as described herein. During heating operation, it is possible that at least some microwave energy will not be absorbed by biomass material being heated or other components within the assembly. This non-absorbed, escaped, or “leaked,” microwave energy can be unsafe, undesirable, or otherwise beneficial to avoid in practice. In order to address this shortcoming, one or more movable and/or pivotable flaps can be positioned at the inlet tunnel, the outlet tunnel, or both.

In various embodiments, a microwave absorbing, deflecting, or blocking flap, for inlet or outlet of biomass material can comprise a flexible mesh configured to feely pivot when contacted by moving biomass material as described herein. Inlet and/or outlet microwave suppression tunnels can have rounded, rectilinear, or a combination of the two for an outline along the various tunnels.

In various embodiments, the various microwave suppression tunnels are preferably in a substantially horizontal position, but preferably at an angle of no more than 45 degrees from horizontal.

FIG. 29A is a cross-sectional end view of a U-shaped microwave suppression tunnel configuration 500A with a top-mounted pivoting mesh flap 506 in a closed position. Attachment points 502 show one alternative mounting configuration that allows flap 506 to pivot within U-shaped flap surround 508. The flap 506 can pivot along a top flap portion or axis 504, or can bend alternatively when a pressure is applied to the flap 506.

FIG. 29B is a cross-sectional end view of a U-shaped microwave suppression tunnel configuration 500B, similar to 500A of FIG. 29A with the mesh flap 506 in a partially open position. As biomass material (e.g., particles, clumps, etc.) are moved along a trough defined by surround 508, flap 506 can be caused to pivot or bend such that an opening 510 between the flap 506 and the surround 508 is revealed. Opening 510 can allow biomass material to pass while allowing minimal microwaves to escape. Biomass material causing flap 506 to open can at least partially block microwaves that would otherwise have escaped the microwave suppression tunnel (e.g., outlet suppression tunnel 200 or inlet suppression tunnel 202, among other embodiments described herein).

FIG. 29C is a cross-sectional end view of the U-shaped microwave suppression tunnel configuration 500C similar to 500A of FIG. 29A with the mesh flap 506 in a fully open position, causing a larger opening 510 than in configuration 500B.

The embodiments shown in FIGS. 29A-29C can also be configured to include a rectangular flap 606 with a corresponding rectangular tunnel or chute surround 608, as shown in FIGS. 30A-30C.

FIG. 30A is a cross-sectional end view of a rectangular microwave suppression tunnel configuration 600A with a top-mounted pivoting mesh flap 606 in a closed position. Attachment points 602 show one alternative mounting configuration that allows flap 606 to pivot within rectangular flap surround 608. The flap 606 can pivot along a top flap portion or axis 604, or can bend alternatively when a flowing material pressure is applied to the flap 606.

FIG. 30B is a cross-sectional end view of a rectangular microwave suppression tunnel configuration 600B, similar to 600A of FIG. 30A with the mesh flap in a partially open position. As biomass material is moved along a trough defined by surround 608, flap 606 can be caused to pivot or bend such that an opening 610 between the flap 606 and the surround 608 is revealed. Opening 610 can allow biomass material to pass while allowing minimal microwaves to escape. Material causing flap 606 to open can at least partially block microwaves that would otherwise have escaped the microwave suppression tunnel.

FIG. 30C is a cross-sectional end view of the rectangular microwave suppression tunnel configuration 600C similar to 600A of FIG. 30A with the mesh flap 606 in a fully open position, causing a larger opening 610 than in configuration 600B.

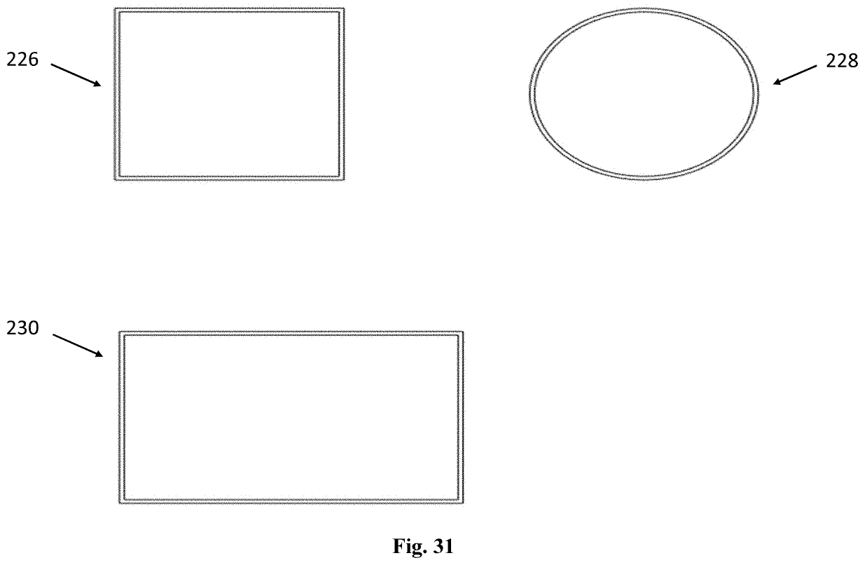

Many other microwave suppression system flap and tunnel configurations are also contemplated in this disclosure, and the examples above are merely shown as selected embodiments. Various embodiments and alternative cross-section shapes of chute are shown at FIG. 31. A generally square chute cross-section is shown at 226, a generally round chute cross-section is shown at 228, and a generally rectangular chute is shown at 230. Any other shape of chute or suppression tunnel (and correspondingly shaped flap[s]) is also contemplated herein.

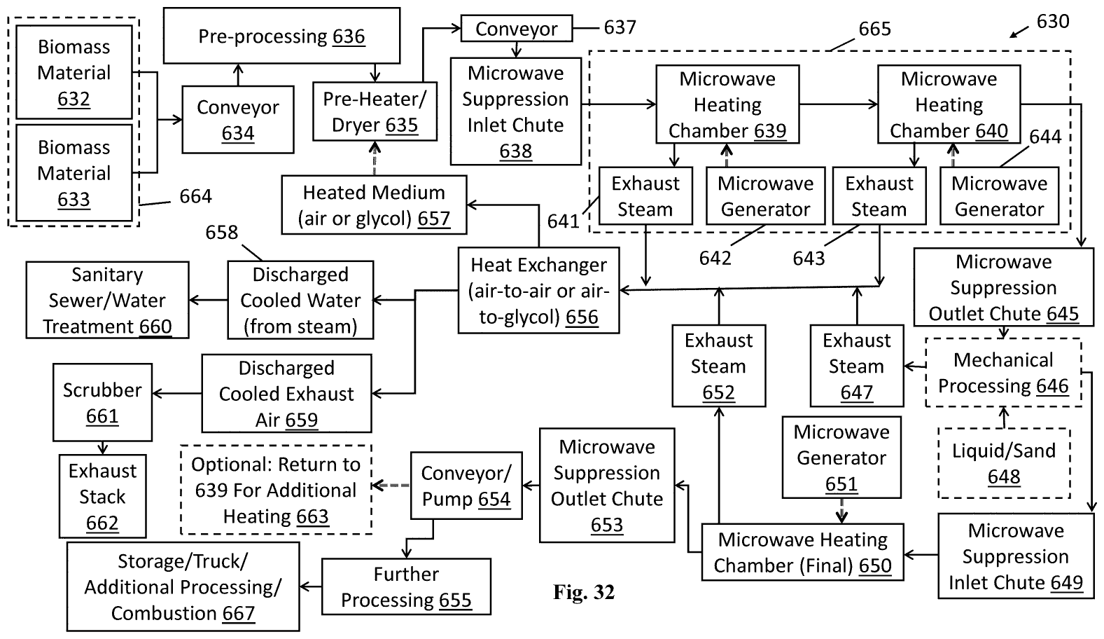

FIG. 32 is a flowchart of a process 630 according to embodiments of the present disclosure.

Process 630 can start with operations 632 and/or 633. At operation 632 of process 630, one or more hoppers (e.g., containers, trailers, rail cars, etc.) or other source of biomass material are received and optionally weighed. At operation 632, the one or more hoppers or other source of biomass material are optionally received and also optionally weighed. Any other material, such as an additional biomass material, sand, or the like, can be received at operation 633. In various alternative embodiments, and as shown at 664, multiple bins of various biomass materials and/or additives can optionally be combined with different biomass materials and/or other materials (e.g., biomass materials of different types, processing levels, consistencies, energy content, or sand, etc.) to obtain a biomass material blend. The optional biomass material blend for processing is referred to as “biomass material” (or simply “material”) below for simplicity. For example, certain types of biomass material may be mixed in small quantities to another biomass material for processing according to various properties.

Next, process 630 proceeds to operation 634, where a conveyor (e.g., a loader unit) carries biomass material to an optional pre-heater (or pre-chiller) or drier at 635. The biomass materials and/or other materials from 632/633 can be assessed, and can be mechanically processed, such as being milled, screened, filtered, sorted, shredded, emulsified, wetted, or crushed at operation 636 (optionally before operation 635). In some cases, it may be beneficial to reduce a chunk size of a biomass material being processed. Optionally, a moisture/water content of the biomass material can be determined or an average moisture content level for the type of biomass material can be estimated and entered, particularly if the biomass material is received as a liquid-based, liquid-suspended, or otherwise finely crushed, flowable form or the like. Various slurries can include particles ranging in size from a grain of sand (or larger) to particles as small as a few micrometers (or smaller). By determining an initial moisture content, the initial weight of the biomass material can be used to predict or determine final dry weight and the mass of water to be removed. Also at 635, energy can be transferred to (or optionally away from) the pre-heater or dryer from a heated (or cooled) medium, such as air or glycol from operation 657, as discussed further below.

Following operation 635, the biomass material can be further moved using another conveyor at operation 637 until the biomass material reaches a microwave suppression inlet chute (or tunnel) at operation 638. Other embodiments herein are contemplated that utilize only a single conveyor unit. Next, the biomass material can proceed to a microwave heating chamber (e.g., a trough of a conveyor unit), which can emit heated exhaust steam at 641, and can receive power via microwaves emitted by a microwave generator at 642 (e.g., via one or more waveguides as discussed herein).

Optionally, the biomass material for processing can then proceed to another microwave heating chamber of another conveyor unit at 640, which can also emit exhaust steam at 643 and/or receive microwave energy from another microwave generator at 644 (e.g., a microwave heating unit, etc.). As shown at 665, multiple heating sections can be added to get the required energy input to reach a specific throughput and/or reach a specification or state according to a standard or specification. After the biomass material is sufficiently heated in accordance with desired specifications, the material can proceed to and past a microwave suppression outlet chute (or tunnel) at 645.

As described herein, optionally, various mechanical processing steps are optionally performed. After the biomass material passes the microwave suppression outlet chute at 645, optionally the material can enter a mechanical processing apparatus at 646. Some exemplary mechanical processing apparatuses 646 contemplated include mixers, agitators, crushers, mills (e.g., hammer mills, pug mills, etc.), shredders, sorters, grinders, and the like. The biomass material when in the mechanical processing apparatus 646 (if present) can emit exhaust steam at 647, and can optionally receive a liquid, such as water, sand, or other material at 648. If the liquid is optionally added at 648, the biomass can become a slurry or the like. It is contemplated that in some embodiments no mechanical processing apparatus 646 is used, and the microwave heating chamber 640 can proceed to microwave heating chamber 650 without a mechanical processing apparatus. In various embodiments, biomass processed at 646 can proceed directly to a pellet/briquette forming apparatus, a bio-oil forming apparatus, or any other apparatus for further processing biomass.

If the mechanical processing apparatus 646 is used, and once the biomass material is sufficiently processed at 646, the material can proceed to another microwave suppression inlet chute (or tunnel) at 649.

At 650 (and similar to 639 and 640), the biomass material can proceed to a third microwave heating chamber at 650. The chamber 650 can also receive microwave energy via one or more microwave generator at 651, and exhaust steam can also be used to extract heat from the heated biomass material at 652. Once the biomass material is heated to a desired, final temperature (e.g., according to a desired chemical process) and moisture content level at 650, the biomass material can proceed through another microwave suppression outlet chute at 653, and can proceed via a conveyor 654 (or pump, etc.) to a storage medium, such as a silo, tank, boat, or shipping train/truck (or other transportation options) at 667, among other destinations for storage or use, including at various remote locations or for additional processing locally or remotely, such as in the form of solids (pellets, briquettes, powders or the like as discussed herein), gases (e.g., combustible gases), fluids, liquids (e.g., biofuels, bio-oils, etc.), and combinations thereof. At 655, the processed biomass can optionally be further processed into pellets/briquettes, bio-oil, or the like, and such processing can occur optionally prior to the storage, trucking, pumping, and/or additional processing at 667.

If it is determined that the biomass material may benefit from additional heating and/or drying, at 663, the biomass material being processed can be returned to, e.g., microwave heating chamber 639 (e.g., via microwave suppression inlet chute 638) for additional processing. Biomass material can be returned for additional processing two, three, four or any number of times and suitable based on target specifications of the biomass material. Final processing, e.g., production and/or burning of bio-oils, biochar, various solids, and/or combustible (or other) bio-derived gases of the heated biomass material can then take place on-site or off-site at a specialized location. Biomass-based biomass material processing can include multiple steps and the process 630 can provide more economically viable biomass output product that is more transportable, denser, more homogeneous, more usable as a petroleum product or fossil fuel alternative, etc. compared to received biomass.

Exhaust steam heat received at 641, 643, and/or 652 can be recovered as heat energy using one or more heat exchanger 656. The heat exchanger 656 can be an air-to-air heat exchanger, or an air-to-liquid (e.g., glycol) heat exchanger in various embodiments. The heat exchanger 656 can provide heat via a heated (or optionally cooled) medium at 657 to be used in the pre-heater (or optionally pre-cooler or freezer) or dryer 635 as discussed above.

Heat exchanger at 656 can discharge cooled (or optionally heated) water (from steam) at 658 and/or discharged cooled exhaust air at 659. The discharged water at 658 can then proceed to a sanitary sewer or water processing at 660. Furthermore, the discharged cooled (or optionally heated) exhaust air at 659 can proceed to an optional scrubber at 661, and then to one or more exhaust stacks at 662. The optional scrubber at 661 can condense steam and reduce odors, emissions, and the like.

In some embodiments, an example shielding mesh used for blocking or absorbing microwave emissions can be an aluminum mesh with a pitch or opening size of about 0.15″ (3.81 mm) or less. The shielding mesh can be optionally encapsulated or coated in a protective substance, such as silicone or the like. In some embodiments, such silicone can reduce the likelihood of screens touching and resulting arcing. Reducing arcing between screens can prolong useful life of the screen. Also contemplated is an aluminum particle filled silicone structure. Other variations and types of shielding mesh also contemplated are discussed below. Various flaps described herein can utilize a shielding mesh, as described above.

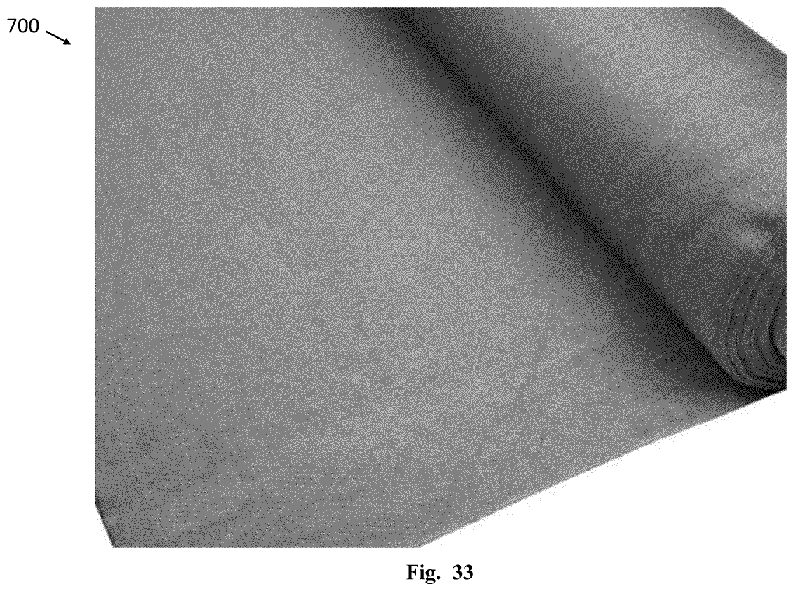

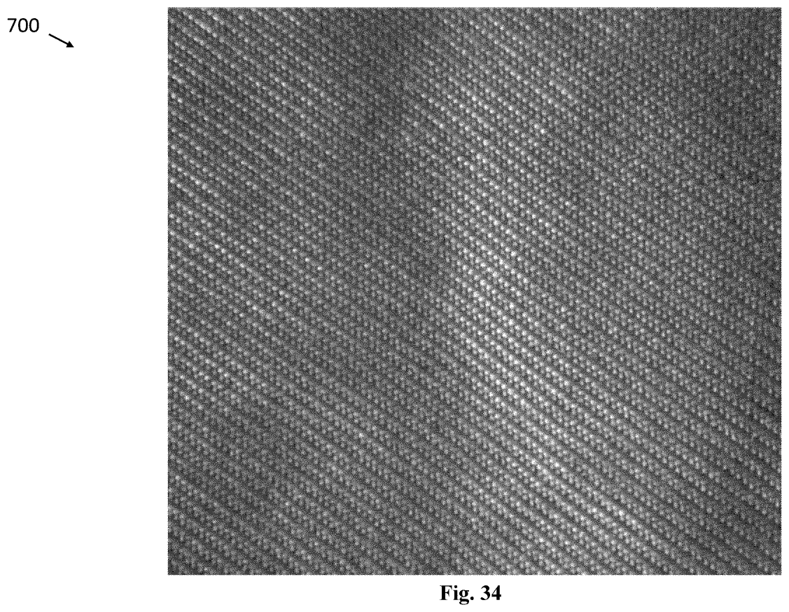

FIGS. 33 and 34 show an embodiment of stainless steel RFI shielding mesh 700. The mesh 700 can be a carbon cover metal.

The shielding mesh 700 can be sourced from Aaronia USA/Aaronia AG. The shielding mesh 700 can be an 80dB Stainless Steel RFI Shielding Aaronia X-Steel model, which can provide military or industrial grade screening to meet various demanding usage cases. In some embodiments, the shielding mesh 700 can be coated with a polytetrafluoroethylene (i.e., PTFE or “Teflon”) coating, silicone, polyurethane, plastic, or the like.

The steel mesh 700 can be highly durable, effective up to about 600° C., operate under a very high frequency range, and be permeable to air. In more detail, shielding mesh 700 is an Aaronia X-Steel component that can operate to at least partially shield both radio frequency (RF) and low frequency (LF) electric fields.

Some specifications of the shielding mesh 700 can include a frequency range of 1 MHz to 50 GHz, a damping in decibels (dB) of 80 dB, a shielding material including stainless steel, a carrier material including stainless steel, a color of stainless steel (silver), a width of 0.25 m or lm or some variation, a thickness of about 1 mm, available sizes of about 0.25 m² or 1 m², a mesh size of approximately 0.1 mm (multiple ply/layer), and a weight of approximately 1000 g/m². The shielding mesh 700 can be suitably durable, and can be configured and rated for use in industrial or other applications, can have a temperature range up to 600° C., can be permeable to air, and permit easy handling.

In some embodiments, the shielding mesh 700 can be electromagnetic compatibility (EMC) screening Aaronia X-Steel from Aaronia AG, which can be made from 100% stainless steel fiber. The shielding mesh 700 can meet various industrial or military standards. The shielding mesh 700 can be very temperature stable for at least 600° C., resists rot, is permeable to air. The shielding mesh 700 can be suitable for EMC screening of air entrances and can be very high protective EMC clothing, etc. The shielding mesh 700 can protect against many kinds of RF fields and can offer a 1000-fold better shielding-performance and protection especially in the very high GHz range as compared to various other types of shielding mesh. The shielding mesh 700 provides high screening within the air permeable EMC screening materials. Application embodiments of the shielding mesh 700 include: Radio & TV, TETRA, ISM434, LTE800, ISM868, GSM900, GSM1800, GSM1900, DECT, UMTS, WLAN, etc.

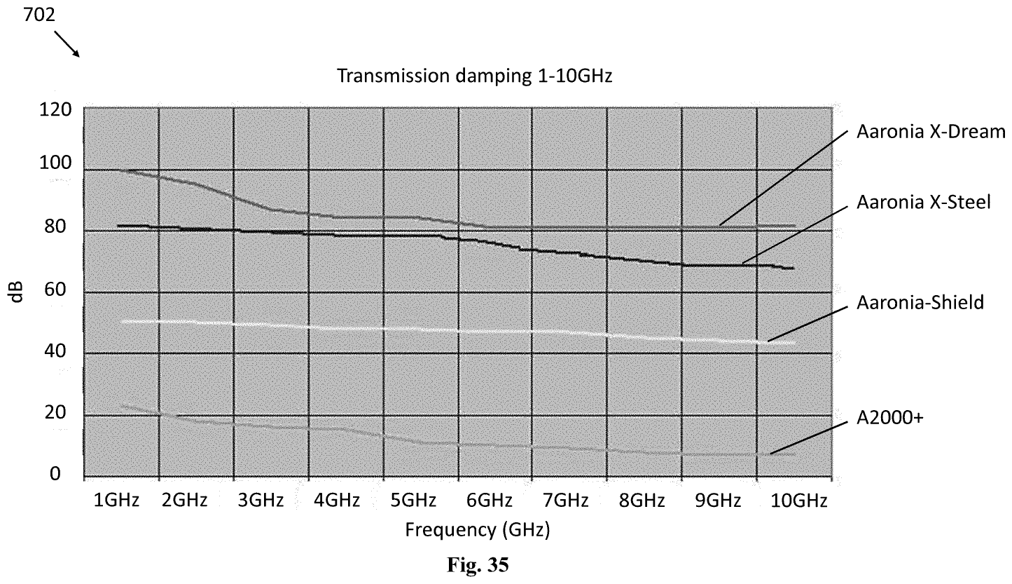

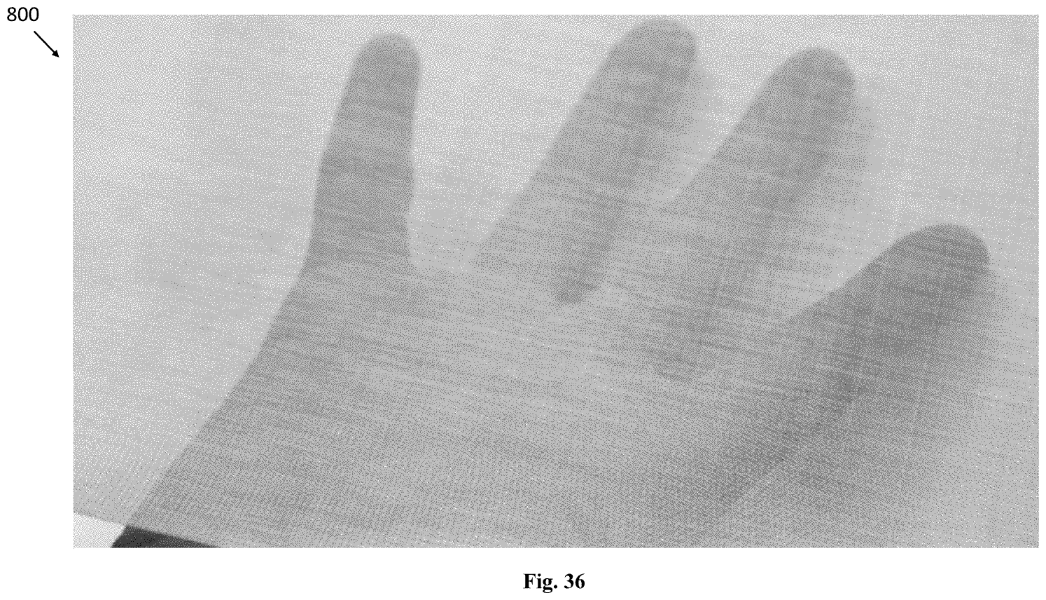

FIG. 35 shows a transmission damping chart 702 for various shielding mesh embodiments from 1-10 GHz in terms of dB for the mesh 700 of FIGS. 33 and 34. As shown, four shielding meshes are depicted. As shown, in descending order for transmission damping across 1-10 GHz, are Aaronia X-Dream, Aaronia X-Steel, Aaronia-Shield, and A2000+.

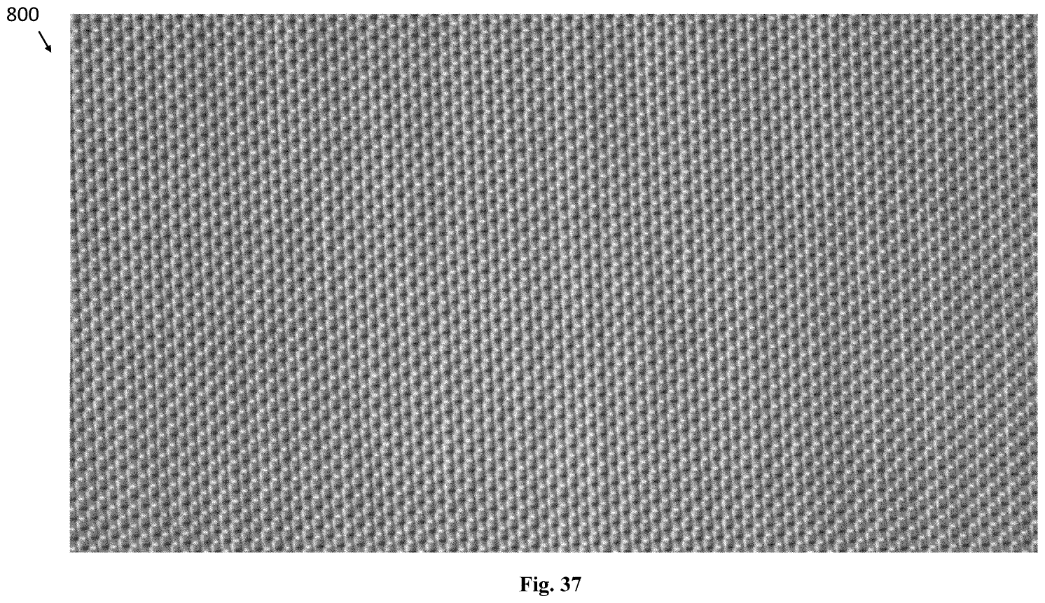

FIGS. 36 and 37 show another embodiment of shielding mesh, a fireproof shielding fabric mesh 800.

The fireproof shielding fabric mesh 800 can be sourced from Aaronia AG, and is a stainless-steel EMC/EMF shielding mesh for usage under extreme conditions. The fireproof shielding mesh 800 is usable up to 1200° C., can be half transparent, has high attenuation, and is both odorless and rot resistant. The fireproof shielding fabric mesh 800 has microwave attenuation as follows: 108 dB at 1 kHz, 100 dB at 1 MHz, 60 dB at 100 MHz, 44 dB at 1 GHz, 30 dB at 10 GHz.

Some specifications of the fireproof shielding fabric mesh 800 include: lane Width: 1 m; thickness: 0.2 mm; mesh size: about 0.1 mm; color: stainless steel; weight: approx. 400 g/m; usable until about 1200° C.; yield strength: 220 Mpa; tensile strength: 550 Mpa; hardness: 180 HB; can be breathable; odorless; transparent; rot resistant; frost proof; washable; foldable; bendable; mesh material: stainless steel.

The fireproof shielding fabric mesh 800 has screening performance for static fields of: 99.9999% to 99.99999% (e.g., when grounded). The fireproof shielding fabric mesh 800 has screening performance for low electric fields of: 99.9999% to 99.99999% (e.g., when grounded).

The fireproof shielding fabric mesh 800 is suitable for industrial applications as well as for research and development. The fireproof shielding fabric mesh 800 has been specifically designed for use under adverse conditions (e.g., salt air, extreme temperatures, vacuum, etc.).

The fireproof shielding fabric mesh 800 is made of 100% stainless steel, is temperature stable up to 1200° C., has a high microwave attenuation, and yet is breathable. The material of mesh 800 absorbs reliable E&H fields. In particular, in the kHz and low MHz range mesh 800 offers a high shielding factor of up to 108dB (E-field). Mesh 800 is easily processed and can in some embodiments be cut with a standard pair of scissors or the like.

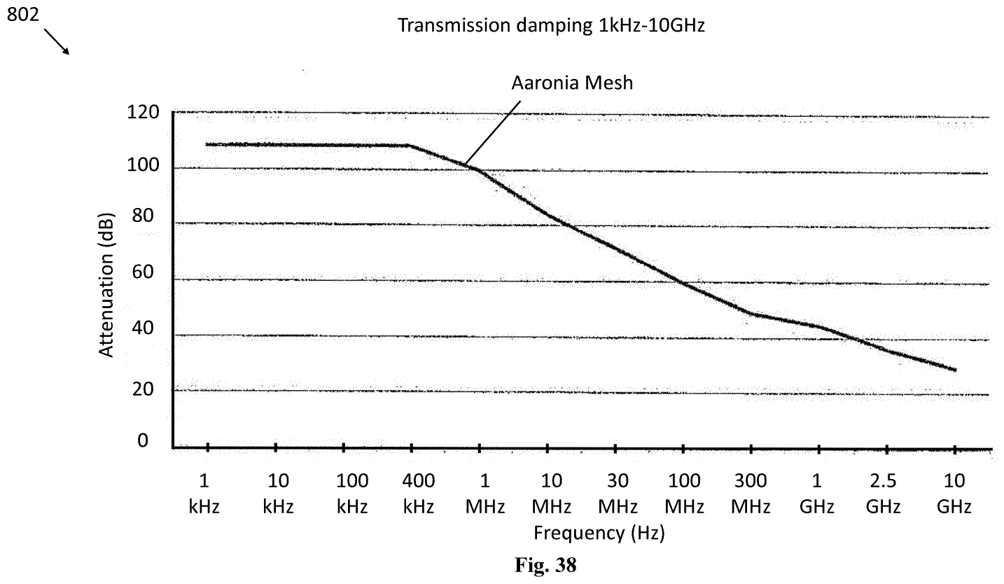

FIG. 38 is a transmission damping chart 802 from 1-10 GHz in terms of dB for the fireproof mesh 800 of FIGS. 36 and 37.

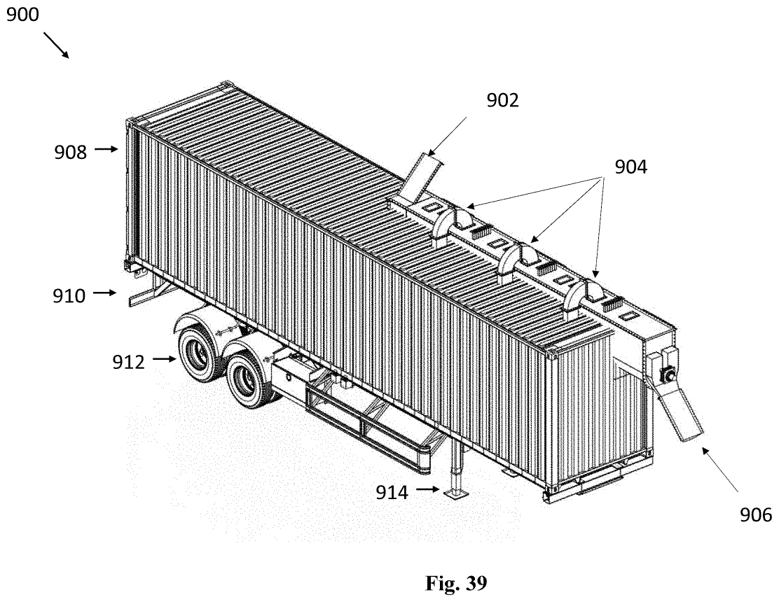

FIG. 39 is a perspective view of another embodiment of a portable, continuous biomass material processing system 900. The system 900 includes a trailer 910 with wheels 912, and a body 908. The body 908 is preferably supported by the trailer 910 and can be removable in some embodiments. The body 908 can be a shipping container or a modified shipping container in various embodiments. As described in other embodiments herein, the system 900 includes an inlet 902, one or more microwave waveguides 904, and an outlet 906, in addition to preferably including one or more microwave generators (not shown) internally to the body 908. The trailer 910 is also equipped optionally with one or more stabilizers 914, which can be used for leveling the system 900 when a tractor or truck (not shown) is removed from the trailer 910. The stabilizers 914 can be telescopic and adjustable in length. The system 900 is preferably substantially level when prepared for biomass material heating operation. As the system 900 is portable and/or towable, it is easily transported between various material processing sites and/or facilities. Smaller and/or scaled-down versions of the system 900 can meet certain target temperatures and heating times according to certain physical and mechanical limitations and constraints. System 900 also optionally includes one or more mechanical processing apparatuses as described herein, either internally or externally.

With reference to portable systems such as 900, in some embodiments a biomass sourcing site or processing facility can be equipped with an auger configured to deliver biomass material from a pile, conveyor, or truck hauling biomass material to be processed. In some cases, a clearance height of the auger can be insufficient to get system 900 unit under the auger. An additional conveyor can in such cases be implemented to bridge a gap or otherwise connect a storage facility or source of material to the system 900. It is contemplated that some additional form of material handling equipment can be used to adapt system 900 to an existing system, setup, or facility.

In addition to microwave heating, fluidized beds (including reactors, and in various bubbling or circulating types) can be utilized for heating (or other treatment or processing) of biomass, e.g., before, after, or during a thermal pre-treatment of biomass using a microwave-based heating system.

Various embodiments that utilize fluid bed reactors for biomass heating, also known as fluidized beds, are discussed herein. Various existing auger-based heating systems, such as U.S. Pat. No. 6,349,658 B1 (Tyer, herein) describe auger combustors with fluidized beds.

Biomass pyrolysis in fluidized bed and auger reactors is also discussed in Aramideh, Soroush, “Numerical simulation of biomass fast pyrolysis in fluidized bed and auger reactors” (2014). Graduate Theses and Dissertations. 14093. URL: https://lib.dr.iastate.edu/etd/14093. (Aramideh, herein) Furthermore, combustion of biomass in fluidized beds is discussed in “Combustion of Biomass in Fluidized Beds: A Review of Key Phenomena and Future Perspectives” by K. Y. Kwong and E. J. Marek, Energy Fuels 2021, 35, 16303-16334. URL: https://doi.org/10.1021/acs.energyfuels.1c01947. (Kwong, herein).

Aramideh discusses producing solid residue, biochar, and unreacted biomass, in addition to tar and syngas gaseous products, using a furnace-heated auger (see FIG. 4.11, page 72). The microwave heating systems, methods, and the like described herein can utilize various aspects of biomass heating as described in Aramideh as applicable. Aramideh further discusses various pyrolysis techniques in Chapter 2, starting on page 8. For example, FIG. 2.1 of page 10 of Aramideh, shows a fluidized bed reactor schematic. According to the present disclosure, a fluidized bed reactor, such as shown in Aramideh, can be bolstered and modified to be used in conjunction with disclosed microwave-heated conveyor system(s) and methods.

Embodiments in this disclosure, including aspects of various apparatuses, processes and methods described in Tyer, Kwong, and/or Aramideh, can be used in combination with various aspects of continuous or batch type microwave heating of biomass using conveyors units such as those employing helical augers.

In some examples, the various “pre-treatment,” “feeder,” and “auger” that lead into the sand bed of the fluidized bed reactor of Aramideh can be replaced with various microwave-heated biomass thermal treatment conveyor-based systems as described herein. For example, biomass to be combusted, further processed, etc., such as in a fluidized bed reactor, can be first or prior processed using microwave and conveyorized heating in systems described herein. In further embodiments, biomass can be pre-treated using microwave-based heating systems described herein for further heating at a separate unit and/or location using various fluidized bed reactor. In further embodiments, any of various fluidized bed techniques known in the art can be applied to, either in conjunction with, in series with, or entirely separate from the microwave heating and processing techniques and systems, as applied to biomass material, as described herein.

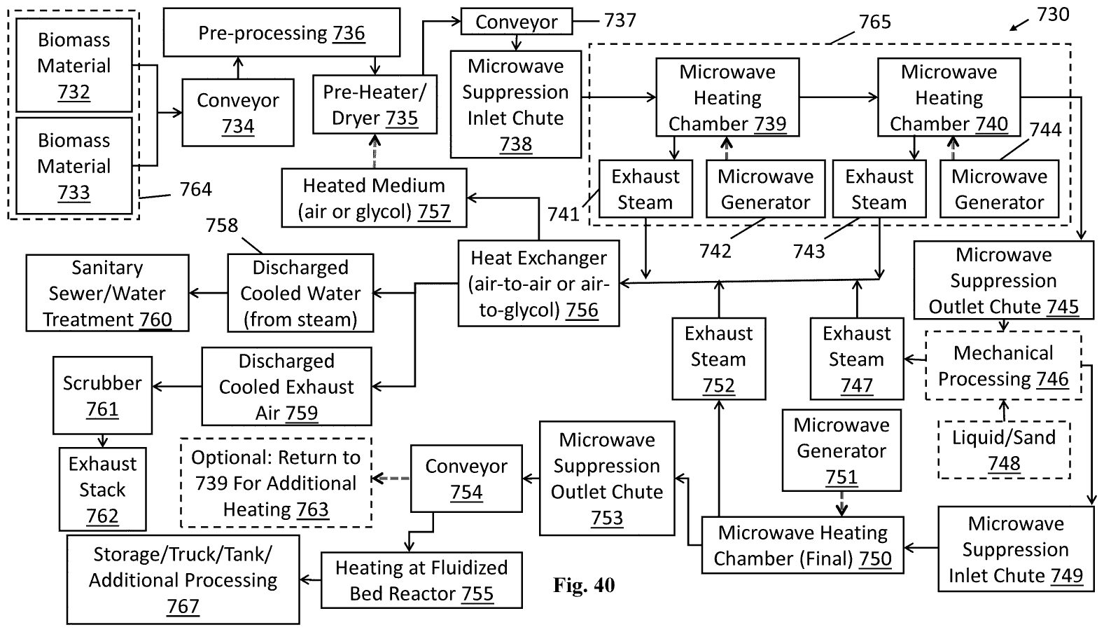

FIG. 40 is a flowchart of a process 730 according to embodiments of the present disclosure. Process 730 can be similar to process 630 of FIG. 32, above, with the exception of changes as noted herein as applied to processing biomass material for further or concurrent processing using a fluidized bed reactor or the like. Various embodiments of fluidized beds as used herein can incorporate a fluid or gaseous source, including a storage tank, compressor, pump and the like, and the fluid or gaseous source can be applied, e.g., to a lower part of a reactor or vessel so as to fluidize a substance, such as glass, sand, metal particles housed within the reactor or vessel.

Process 730 can start with operations 732 and/or 733. At operation 732 of process 730, one or more hoppers (e.g., containers, trailers, rail cars, boats, etc.) or other source of biomass material are received and optionally weighed. At operation 732, one or more hoppers or other source of biomass material are optionally received and also optionally weighed. Any other material, such as an additional biomass material, sand, or the like, can be received at operation 733. In various alternative embodiments, and as shown at 764, multiple bins of various biomass materials and/or additives can optionally be combined with different biomass materials and/or other materials (e.g., biomass materials of different types, processing levels, consistencies, energy content, or sand, etc.) to obtain a biomass material blend. The optional biomass material blend for processing is referred to as “biomass material” (or simply “material”) below for simplicity. For example, certain types of biomass material may be mixed in small quantities to another biomass material for processing according to various properties.

Next, process 730 proceeds to operation 734, where a conveyor (e.g., a loader unit) carries biomass material to an optional pre-heater (or pre-chiller) or drier at 735. The biomass materials and/or other materials from 732/733 can be assessed, and can be milled, screened, filtered, sorted, shredded, emulsified, wetted, or crushed at operation 736 (optionally before operation 735). In some cases, it may be beneficial to reduce a chunk size of a biomass material being processed. Optionally, a moisture/water content of the biomass material can be determined or an average moisture content level for the type of biomass material can be estimated and entered, particularly if the biomass material is received as a liquid-based, liquid-suspended, or otherwise finely crushed, flowable form or the like. Various slurries can include particles ranging in size from a grain of sand (or larger) to particles as small as a few micrometers (or smaller). By determining an initial moisture content, the initial weight of the biomass material can be used to predict or determine final dry weight and the mass of water to be removed. Also at 735, energy can be transferred to (or optionally away from) the pre-heater or dryer from a heated (or cooled) medium, such as air or glycol from operation 757, as discussed further below.

Following operation 735, the biomass material can be further moved using another conveyor at operation 737 until the biomass material reaches a microwave suppression inlet chute (or tunnel) at operation 738. Other embodiments herein are contemplated that utilize only a single conveyor unit. Next, the biomass material can proceed to a microwave heating chamber (e.g., a trough of a conveyor unit), which can emit heated exhaust steam at 741, and can receive power via microwaves emitted by a microwave generator at 742 (e.g., via one or more waveguides as discussed herein).

Optionally, the biomass material for processing can then proceed to another microwave heating chamber of another conveyor unit at 740, which can also emit exhaust steam at 743 and/or receive microwave energy from another microwave generator at 744 (e.g., a microwave heating unit, etc.). As shown at 765, multiple heating sections can be added to get the required energy input to reach a specific throughput and/or reach a specification or state according to a standard or specification. After the biomass material is sufficiently heated in accordance with desired specifications, the material can proceed to and past a microwave suppression outlet chute (or tunnel) at 745.

As described herein, optionally, various mechanical processing steps are optionally performed. After the biomass material passes the microwave suppression outlet chute at 745, optionally the material can enter a mechanical processing apparatus at 746. Some exemplary mechanical processing apparatuses 746 contemplated include mixers, agitators, crushers, mills (e.g., hammer mills, pug mills, etc.), shredders, filters, sorters, grinders, and the like. The biomass material when in the mechanical processing apparatus 746 (if present) can emit exhaust steam at 747, and can optionally receive a liquid, such as water, sand, or other material at 748. If the liquid is optionally added at 748, the biomass can become a slurry or the like. It is contemplated that in some embodiments no mechanical processing apparatus 746 is used, and the microwave heating chamber 740 can proceed to microwave heating chamber 750 without a mechanical processing apparatus. In various embodiments, biomass processed at 746 can proceed directly to a fluidized bed reactor at 755. In various embodiments the fluidized bed reactor 755 can be integral with one or more conveyor units as described herein.

If the mechanical processing apparatus 746 is used, and once the biomass material is sufficiently processed at 746, the material can proceed to another microwave suppression inlet chute (or tunnel) at 749.

At 750 (and similar to 739 and 740), the biomass material can proceed to a third microwave heating chamber at 750. The chamber 750 can also receive microwave energy via one or more microwave generator at 751, and exhaust steam can also be used to extract heat from the heated biomass material at 752. Once the biomass material is heated to a desired, final temperature (e.g., according to a desired chemical process) and moisture content level at 750, the biomass material can proceed through another microwave suppression outlet chute at 753, and can proceed via a conveyor 754 to a storage medium, such as a silo, tank, boat, or shipping train/truck (or other transportation options) at 767, among other destinations for storage or use, including at various remote locations or for additional processing locally or remotely, such as in the form of solids (including powders, etc.), gases, fluids, and combinations thereof. At 755, the processed biomass can be further processed into combustible solids (pellets, briquettes, powders or the like as discussed herein), gases, fluids, liquids (e.g., bio-oil), and combinations thereof, and such processing can occur optionally prior to the storage, trucking, pumping, and/or additional processing at 767.

If it is determined that the biomass material may benefit from additional heating and/or drying before optionally passing to the fluidized bed reactor 755, at 763, the biomass material being processed can be returned to, e.g., microwave heating chamber 739 (e.g., via microwave suppression inlet chute 738) for additional processing. Biomass material can be returned for additional processing two, three, four or any number of times and suitable based on target specifications of the biomass material. Final processing, e.g., the production or burning of biofuels/bio-oils, biochar (including sand biochar and/or fine biochar), and various combustible bio-derived gases, of the heated biomass material can then take place on-site or off-site at a specialized location. Biomass-based biomass material processing can include multiple steps and the process 730 can provide more economically viable biomass output product that is more transportable, denser, more homogeneous, more usable as a petroleum product or fossil fuel alternative, etc. compared to received biomass.

Exhaust steam heat received at 741, 743, and/or 752 can be recovered as heat energy using one or more heat exchanger 756. The heat exchanger 756 can be an air-to-air heat exchanger, or an air-to-liquid (e.g., glycol) heat exchanger in various embodiments. The heat exchanger 756 can provide heat via a heated (or optionally cooled) medium at 757 to be used in the pre-heater (or optionally pre-cooler or freezer) or dryer 735 as discussed above.

Heat exchanger at 756 can discharge cooled (or optionally heated) water (from steam) at 758 and/or discharged cooled exhaust air at 759. The discharged cooled water at 758 can then proceed to a sanitary sewer or water processing at 760. Furthermore, the discharged cooled exhaust air at 759 can proceed to an optional scrubber at 761, and then to one or more exhaust stacks at 762. The optional scrubber at 761 can condense steam and reduce odors, emissions, and the like.

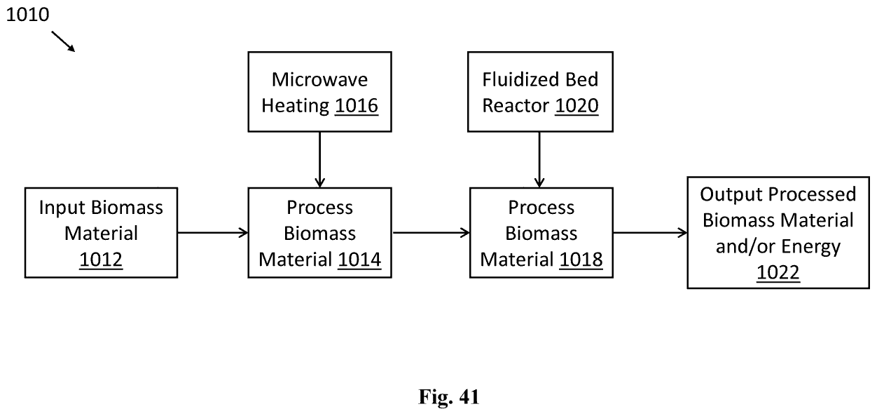

FIG. 41 is a flowchart of another process 1010 according to various embodiments. Process 1010 is shown schematically, and is not intended to show all details as described in various embodiments herein. As shown in process 1010, an input of a quantity of biomass material is received at 1012. The received biomass is the processed at 1014. As shown, the biomass material is processed at 1014 using microwave processing and heating at 1016. As described herein, the microwave heating of 1016 can utilize one or more conveyor units, microwave energy generator, and/or one or more suppression tunnels as described herein. According to process 1010, after (or optionally during) microwave heating, the biomass material is processed again at 1018. The processing at 1018 can include heating (or other processing) using a fluidized bed reactor at 1020. The heating (or other processing) at the fluidized bed reactor at 1020 as shown provide an additional step of heating following the microwave heating 1016 received at 1014. Following the fluidized bed reactor heating (or other processing) 1020 and processing 1018, one or more output processed biomass material (product) and/or energy output can be produced at 1022.

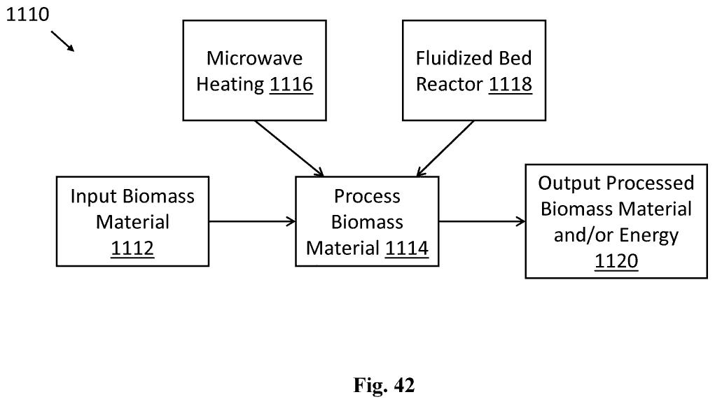

FIG. 42 is a flowchart of yet another process 1110 according to various embodiments. Process 1110 can be similar to process 1010, except that microwave heating 1116 and fluidized bed reactor processing 1118 can be used at a single biomass material processing step 1114. The process 1110 starts by receiving an input quantity of biomass material at 1112. Next, the biomass material is processed at 1114 as described above, using a combination of microwave heating (e.g., using microwave heated conveyor units and/or microwave suppression tunnels described herein), and fluidized bed reactor processing (e.g., heated by any suitable energy source). Following the processing at 1114, one or more output processed biomass material (product), byproduct, and/or energy output can be produced at 1120.

In processes 1010 and 1110, although various microwave and fluidized bed reactor processing steps and options are shown, it is to be understood that any of various heating, chemical, mechanical, and the like processing steps can be introduced at any point, and that additional or variations on the heating and processing steps are also contemplated herein.

As described in this disclosure, biomass material is an embodiment of one or more material to be heated and/or processed as described herein. Biomass material, such as any natural or human-made or human-modified material, or any liquid, solids, or slurries thereof, can be heated and/or processed using microwaves as described in further detail herein. As discussed above, various materials to be processed as contemplated herein can be sourced from a surface (e.g., fields, forests, farms, etc.) can be unearthed or removed from below ground, or can be otherwise removed or sourced from natural or man-made deposits.

As used in this disclosure, a conveyor or conveyor unit can be any vessel or mechanism that moves biomass material from an inlet to an outlet. The material being heated can be carried in various embodiments by another type of conveyance mechanism, such as by an auger or various types of conveyor belts. Therefore, in some alternative embodiments a conveyorized modular industrial microwave power system can be employed instead of an auger-based system such as system 100. A conveyor unit can also be referred to more generally as an auger.

Based on power or other specification requirements, two or more microwave power modules or heating units can be installed on the same conveyor. To assure uniform heat distribution in a large variety of load configurations, a multimode cavity can be provided with a waveguide splitter with dual microwave feed points and mode stirrers.

In embodiments that use a conveyor belt, a belt material and configuration are selected based on the nature of the material to be heated. Each end of the conveyor is preferably also provided with a special vestibule to suppress any microwave leakage. Air intake and exhaust vents or ports are provided for circulating air to be used in cases where vapors or fumes are developed during the heating process.

Unlike home microwave ovens, examples of industrial microwave-based heating systems contemplated herein preferably separate microwave generation from a heating/drying cavity such as a trough or housing. An industrial microwave heating system can be constructed to use one or more microwave generator units. Examples of microwave generators and heating units come in 75 kW and 100 kW (output power) models. Using specialized ducts called waveguides or microwave guides, the microwave energy is carried to one or more industrial microwave cavities. In a conveyor belt-based embodiment, a conveyor belt, auger, etc. carries the product through the cavities. A simple system may include one microwave generator and one cavity, while a larger and/or more complex system may have a dozen generators and six cavities. This inherent modularity provides flexibility in scaling a system, or building systems, which can be expanded in the future.

The disclosures of published PCT patent applications, PCT/US2017/023840 (WO2017165664), PCT/US2013/039687 (WO2013166489), PCT/US2013/039696 (WO2013166490), PCT/US2020/040464 (WO2021003250), and PCT/US2021/033145 (filed May 19, 2021), PCT/US2021/034241 (filed May 26, 2021), including an application of the microwave thermal treatment of waste applied to biomass material discussed herein, as applicable; and U.S. Provisional Application with Ser. No. 62/241,745 (filed Sep. 8, 2021) are each hereby incorporated by reference in their respective entireties.

In alternative embodiments, microwave suppression flap(s) can be rigid and non-flexible, but can be attached to top portion using hinges or any other articulating hardware as known in the art. Alternative hardware and flap fastening arrangements are also contemplated.

Unless otherwise defined, all technical and scientific terms used in this disclosure have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

These and other advantages will be apparent to those of ordinary skill in the art. While the various embodiments of the invention have been described, the invention is not so limited. Also, the method and apparatus of the present invention is not necessarily limited to any particular field, but can be applied to any field where an interface between a user and a computing device is applicable.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

Selected embodiments of the present disclosure:

Embodiment 1. A system for processing biomass material, comprising:
at least one microwave generator;
at least one microwave guide operatively connecting the at least one microwave generator to at least a first conveyor unit;
the first conveyor unit provided in a first housing that comprises at least one opening configured to receive microwave energy via a first microwave guide; and
wherein the first conveyor unit is configured to receive and process a quantity of biomass material, which includes heating the biomass material to a first temperature by applying microwave energy to the biomass material within the first housing.

Embodiment 2. The system of embodiment 1, wherein the heating the biomass material to the first temperature causes the biomass material to undergo a chemical reaction or thermal conversion.

Embodiment 3. The system of embodiment 2, wherein the chemical reaction or thermal conversion comprises at least one of pyrolysis, torrefaction, gasification, and liquefaction.

Embodiment 4. The system of embodiment 1, wherein the biomass material is heated to the first temperature for a first time period within the first housing.

Embodiment 5. The system of embodiment 1, wherein the quantity of biomass material contains at least some discarded or byproduct material from a previous process.

Embodiment 6. The system of embodiment 1, wherein the quantity of biomass material contains woody biomass.

Embodiment 7. The system of embodiment 1, wherein the heating the biomass material to a first temperature by applying microwave energy to the biomass material within the first housing causes the biomass material to become denser.

Embodiment 8. The system of embodiment 1, wherein the heating the biomass material to a first temperature by applying microwave energy to the biomass material within the first housing causes the biomass material to become more homogeneous.

Embodiment 9. The system of embodiment 1, wherein the heating the biomass material to a first temperature by applying microwave energy to the biomass material within the first housing causes the biomass material to become more transportable.

Embodiment 10. The system of embodiment 1, further comprising an apparatus configured to receive the quantity of biomass material and produce pellets and/or briquettes based on the received biomass material.

Embodiment 11. The system of any preceding embodiment, further comprising a second conveyor unit, the second conveyor unit provided in a second housing that comprises at least one opening configured to receive microwave energy via a second microwave guide, wherein the second conveyor is configured to receive and process the quantity of biomass material, which includes heating the biomass material to a second temperature greater than the first temperature by applying microwave energy to the material within the second housing.

Embodiment 12. The system of any preceding embodiment, wherein the at least one microwave generator comprises a plurality of microwave generators.

Embodiment 13. The system of any preceding embodiment, wherein the at least one microwave guide comprises a plurality of microwave guides.

Embodiment 14. The system of any preceding embodiment, wherein the quantity of biomass material being processed has an initial maximum particle or chunk size, and wherein the size is reduced to a second size by milling, crushing, shredding, screening, filtering, and/or sorting.

Embodiment 15. The system of any preceding embodiment, further comprising a third conveyor unit provided in a third housing that comprises at least one opening configured to receive microwave energy via a third microwave guide, and wherein the third conveyor is configured to receive and process the quantity of biomass material, which includes heating the quantity of biomass material to a third temperature greater than the second temperature by applying microwave energy to the material within the third housing.

Embodiment 16. The system of any preceding embodiment, further comprising a first loader unit configured to receive and feed the biomass material to the first conveyor unit.

Embodiment 17. The system of any preceding embodiment, further comprising at least one microwave suppression system, comprising:
at least an inlet and an outlet; and
a tunnel within at least one of the inlet and outlet that comprises at least one flexible and/or movable microwave reflecting component within the tunnel, and
wherein at least a portion of the at least one movable microwave reflecting component is configured to be deflected as the biomass material passes through the tunnel and then returning to a resting, closed position when the biomass material is no longer passing through the tunnel.

Embodiment 18. The system of any preceding embodiment, wherein the movable microwave reflecting component is a mesh flap.

Embodiment 19. The system of any preceding embodiment, wherein the movable microwave reflecting component comprises stainless steel.

Embodiment 20. The system of any preceding embodiment, wherein the movable microwave reflecting component is coated with a protective material.

Embodiment 21. The system of any preceding embodiment, wherein the protective material is selected from the group consisting of silicone, Teflon, polyurethane, and plastic.

Embodiment 22. The system of any preceding embodiment, wherein the movable microwave reflecting component comprises a plurality of strips.

Embodiment 23. The system of any preceding embodiment, wherein the movable microwave reflecting component comprises a plurality of chains.

Embodiment 24. The system of any preceding embodiment, further comprising at least a second microwave suppression system.

Embodiment 25. The system of any preceding embodiment, wherein at least one of the first, second, and third conveyor units comprises at least one helical auger.

Embodiment 26. The system of any preceding embodiment, further comprising a motor configured to rotate the at least one helical auger.

Embodiment 27. The system of any preceding embodiment, wherein the motor has a power rating of approximately 50-150 kilowatts.

Embodiment 28. The system of any preceding embodiment, wherein the motor has a power rating of approximately 70-130 kilowatts.

Embodiment 29. The system of any preceding embodiment, wherein the motor has a power rating of approximately 80-110 kilowatts.

Embodiment 30. The system of any preceding embodiment, wherein the motor has a power rating of approximately 90-100 kilowatts.

Embodiment 31. The system of any preceding embodiment, further comprising a mechanical processing apparatus configured to receive the quantity of biomass material being processed from a conveyor unit, wherein the quantity of biomass material enters a different conveyor unit after exiting the mechanical processing apparatus.

Embodiment 32. The system of any preceding embodiment, wherein the mechanical processing apparatus is a hammer mill, crusher, pugmill, a drum mixer, or a mixing chamber.

Embodiment 33. The system of any preceding embodiment, further comprising a lifting conveyor configured to receive biomass material being processed from the mechanical processing apparatus and configured to lift the quantity of biomass material vertically before the biomass material enters a different conveyor unit.

Embodiment 34. The system of any preceding embodiment, wherein the quantity of biomass material being processed comprises a product to be dried.

Embodiment 35. The system of any preceding embodiment, wherein the quantity of biomass material comprises a slurry.

Embodiment 36. The system of any preceding embodiment, wherein the quantity of biomass material being processed contains at least some water.

Embodiment 37. The system of any preceding embodiment, wherein the quantity of biomass material being processed contains less than fifty percent water by weight.

Embodiment 38. The system of any preceding embodiment, wherein the quantity of biomass material being processed contains at least fifty percent water by weight.

Embodiment 39. The system of any preceding embodiment, wherein the quantity of biomass material being processed contains between ten and ninety percent water by weight.

Embodiment 40. The system of any preceding embodiment, wherein the quantity of biomass material being processed contains between twenty and eighty percent water by weight.

Embodiment 41. The system of any preceding embodiment, wherein the quantity of biomass material being processed contains between thirty and seventy percent water by weight.

Embodiment 42. The system of any preceding embodiment, further comprising at least one heat exchanger apparatus configured to recover a heat byproduct from the material being processed.

Embodiment 43. The system of any preceding embodiment, wherein the heat byproduct is recovered from the heating of the water within the material being processed.

Embodiment 44. The system of any preceding embodiment, wherein each conveyor unit is configured to receive between 1 and 30 microwave guides via corresponding openings.

Embodiment 45. The system of any preceding embodiment, wherein each conveyor unit is configured to receive between 7 and 10 microwave guides via corresponding openings.

Embodiment 46. The system of any preceding embodiment, wherein the quantity of biomass material being processed receives about 0.33 and 0.44 kilowatts of microwave power per pound, including any moisture present within the material.

Embodiment 47. The system of any preceding embodiment, wherein the quantity of biomass material being processed receives less than 0.33 kilowatts of microwave power per pound, including any moisture present within the material.

Embodiment 48. The system of any preceding embodiment, wherein each conveyor unit has a weight capacity of at least 500 pounds of biomass material.

Embodiment 49. The system of any preceding embodiment, wherein each conveyor unit has a weight capacity of at least 8,500 pounds of biomass material.

Embodiment 50. The system of any preceding embodiment, wherein each conveyor unit has a weight capacity of at least 40,000 pounds of biomass material.

Embodiment 51. The system of any preceding embodiment, wherein the first conveyor unit comprises a baffle configured to restrict the quantity of biomass material being processed as it proceeds through the first housing.

Embodiment 52. The system of any preceding embodiment, wherein a liquid is added to the quantity of biomass material being processed.

Embodiment 53. The system of any preceding embodiment, wherein the quantity of biomass material being processed has a maximum largest dimension of eight inches.

Embodiment 54. The system of any preceding embodiment, wherein the quantity of biomass material being processed has a maximum largest dimension of six inches.

Embodiment 55. The system of any preceding embodiment, further comprising an impactor, shredder, mixer, mesh, screen, filter, brush, mill, or other suitable mechanical device configured to perform a crushing or sorting process or otherwise reduce a maximum largest dimension or increase the density of the quantity of biomass material being processed.

Embodiment 56. The system of any preceding embodiment, wherein the system processes between about 10 tons and about 1000 tons of biomass material per hour.

Embodiment 57. The system of any preceding embodiment, wherein the system processes between about 50 tons and about 100 tons of biomass material per hour.

Embodiment 58. The system of any preceding embodiment, wherein at least some of the quantity of biomass material being processed is milled, crushed, shredded, or reduced in size within or prior to entering the first conveyor unit.

Embodiment 59. The system of any preceding embodiment, wherein the system is modular and portable.

Embodiment 60. The system of any preceding embodiment, wherein the system is contained within one or more trailers.

Embodiment 61. The system of any preceding embodiment, wherein the one or more trailers are transported to various biomass processing locations on demand.

Embodiment 62. The system of any preceding embodiment, wherein at least one conveyor unit comprises a heated auger.

Embodiment 63. The system of any preceding embodiment, wherein the heated auger is a jacketed auger.

Embodiment 64. The system of any preceding embodiment, wherein at least one conveyor unit comprises a non-stick coating.

Embodiment 65. The system of any preceding embodiment, wherein at least one conveyor unit is thermally insulated.

Embodiment 66. The system of any preceding embodiment, wherein the quantity of biomass material is heated to a target temperature at which a chemical reaction of the biomass material occurs, wherein the target temperature is based on desired chemical properties of the quantity of biomass material after processing.

Embodiment 67. A method of processing material, comprising:
receiving a quantity of biomass material at a first conveyor unit provided in a first housing; and
performing a first processing step to the quantity of biomass material within the first conveyor unit using at least one microwave generator coupled to the housing of the first conveyor unit, wherein the biomass material is heated within the first conveyor unit.

Embodiment 68. The method of embodiment 67, further comprising:
receiving the quantity of biomass material at a mechanical processing apparatus, wherein a mixing step is performed to the biomass material within the mechanical processing apparatus.

Embodiment 69. The method of any preceding embodiment, wherein at least some of the quantity of biomass material is milled, crushed, shredded, mixed, blended, reduced in size, and/or homogenized before or during the first processing step.

Embodiment 70. The method of any preceding embodiment, further comprising:
receiving the quantity of biomass material at a second conveyor unit provided in a second housing; and
performing a second processing step to the quantity of biomass material within the second conveyor unit using the at least one microwave generator coupled to the housing of the second conveyor, wherein the biomass material is heated to a greater temperature in the second processing step than in the first processing step.

Embodiment 71. The method of any preceding embodiment, further comprising:
receiving the quantity of biomass material at a third conveyor unit provided in a third housing; and
performing a third processing step to the quantity of biomass material within the third conveyor unit using the at least one microwave generator coupled to the housing of the third conveyor, wherein the biomass material is heated to a greater temperature in the third processing step than in the first or second processing steps.

Embodiment 72. The method of any preceding embodiment, wherein the quantity of biomass material received at the mechanical processing apparatus is received from a conveyor unit, and wherein the biomass material enters a different conveyor unit after exiting the mechanical processing apparatus.

Embodiment 73. The method of any preceding embodiment, wherein the at least first conveyor unit comprises a number and arrangement of conveyor units selected such that a desired result is reached.

Embodiment 74. The method of any preceding embodiment, wherein at least two conveyor units are arranged in series.

Embodiment 75. The method of any preceding embodiment, wherein at least two conveyor units are arranged in parallel.

Embodiment 76. The method of any preceding embodiment, wherein a processing speed of the at least one conveyor unit is adjusted based on the series or parallel arrangement.

Embodiment 77. The method of any preceding embodiment, wherein the processing speed can be reduced to increase heating, or can be increased to reduce heating of the quantity of biomass material being processed in the at least one conveyor unit.

Embodiment 78. The method of any preceding embodiment, wherein for a given processing speed, two or more conveyor units operating in parallel increases a biomass material processing throughput based at least on the number of parallel conveyor units.

Embodiment 79. The method of any preceding embodiment, further comprising using a microwave radar of a frequency different than any heating microwaves to perform at least a level measurement.

Embodiment 80. The method of any preceding embodiment, wherein based on the level measurement at least one of a processing speed and heating power is adjusted.

Embodiment 81. A biomass product made by any system or method of any preceding embodiment.

Embodiment 82. A product or system of any preceding embodiment wherein processing of the quantity of biomass material is continuous.

Embodiment 83. A product or system of any preceding embodiment wherein processing of the quantity of biomass material is in batches.

Embodiment 84. A method for portably providing biomass material processing upon demand, comprising:
receiving a request for processing a first quantity of biomass material at a first location;
determining that the first location has a first group of characteristics that include at least a distance from the first location to an external power source of a first power output and a distance from a source of the biomass material;
deploying a portable system for processing biomass material at the first location based on at least the first quantity of biomass material and the first group of characteristics, the portable system comprising:

at least one power generator configured to provide at least the first power output,

at least one microwave generator operatively coupled to the power generator,

at least one conveyor unit configured to receive and process a quantity of biomass material to achieve at least a target temperature for a target time; and applying microwave energy to the biomass material within the conveyor unit of the portable system.

Embodiment 85. The method of embodiment 84, wherein the processing of the quantity of biomass material operates continuously.

Embodiment 86. The method of embodiment 84, wherein the processing of the quantity of biomass material operates in batches.

Embodiment 87. A microwave suppression system, comprising:
at least an inlet and an outlet; and
a tunnel within at least one of the inlet and outlet that comprises at least one movable mesh flap within the tunnel,
wherein the at least one movable mesh flap is configured to absorb, deflect, or block microwave energy, and wherein the at least one movable mesh flap is configured to be deflected as a quantity of biomass material passes through the tunnel and then to return to a resting, closed position when the biomass material is no longer passing through the tunnel.

Embodiment 88. The microwave suppression system of embodiment 87, wherein the movable mesh flap comprises stainless steel.

Embodiment 89. The microwave suppression system of embodiment 87, wherein the microwave suppression system operates to process biomass material continuously.

Embodiment 90. An apparatus for processing biomass material, comprising:
a conveyor unit comprising a helical auger having an auger shaft provided along an auger rotational axis, the auger configured to rotate in a direction such that a quantity of biomass material received at the conveyor unit is caused to be transported according the auger rotational axis; and
at least one microwave energy generator, each microwave energy generator being operatively connected to a respective microwave guide configured to cause microwaves emitted by the microwave energy generator to heat the biomass material within the conveyor unit by converting the microwaves to heat when absorbed by at least a portion of the quantity of biomass material within the conveyor unit;
wherein the quantity of biomass material is heated using the microwave energy, and wherein the quantity of biomass material is caused to exit the conveyor unit after being heated to a target temperature.

Embodiment 91. The apparatus of embodiment 90, wherein the apparatus processes the quantity of biomass material continuously.

Embodiment 92. The apparatus of embodiment 90, wherein the auger shaft defines an internal auger fluid path provided along the auger rotational axis, and further comprising a fluid management device configured to heat the auger and transfer heat to the quantity of biomass material through the auger, wherein the quantity of biomass material is heated using a combination of the microwave energy and fluidic heat.

Embodiment 93. The apparatus of embodiment 90, further comprising:
a material inlet and a material outlet;
a tunnel within at least one of the biomass material inlet and material outlet that comprises a microwave suppression system;
at least one movable mesh flap within the tunnel, wherein the at least one mesh flap is configured to absorb, deflect, or block microwave energy, and wherein the at least one movable mesh flap is configured by be deflected as the biomass material passes through the tunnel and then returning to a resting, closed position when the material is no longer passing through the tunnel.

Embodiment 94. The apparatus of embodiment 93, wherein the movable mesh flap comprises stainless steel.

Embodiment 95. A method of processing material using microwave energy, comprising:
receiving a quantity of biomass material at a conveyor unit comprising an auger, wherein the biomass material passes through at an inlet microwave suppression tunnel before entering the conveyor unit;
transporting the quantity of biomass material along the conveyor unit by causing the auger to rotate;
heating the quantity of biomass material within the conveyor unit using at least one microwave generator operatively connected to a respective microwave guide configured to cause microwaves emitted by the microwave energy generator to heat the quantity of biomass material within the conveyor unit by converting the microwaves to heat when absorbed by at least a portion of the quantity of biomass material within the conveyor unit; and
causing the heated quantity of biomass material to exit the conveyor unit through an outlet microwave suppression tunnel, wherein the quantity of biomass material that exits the conveyor unit is a chemically-treated product.

Embodiment 96. The method of embodiment 95, wherein the quantity of biomass material is heated to a target temperature before being caused to exit the conveyor unit.

Embodiment 97. The method of embodiment 95, wherein the quantity of biomass material is heated such that it is at least partially chemically processed.

Embodiment 98. The method of embodiment 95, wherein the inlet suppression tunnel comprises:
at least one inlet movable mesh flap within the inlet suppression tunnel,
wherein the at least one inlet movable mesh flap is configured to absorb, deflect, or block microwave energy, and
wherein the at least one inlet movable mesh flap is configured to be deflected as the quantity of biomass material passes through the inlet suppression tunnel and then to return to a resting,
closed position when the quantity of biomass material is no longer passing through the inlet suppression tunnel.

Embodiment 99. The method of embodiment 98, wherein the inlet movable mesh flap comprises stainless steel.

Embodiment 100. The method of embodiment 95, wherein the outlet suppression tunnel comprises:
at least one outlet movable mesh flap within the outlet suppression tunnel,
wherein the at least one outlet movable mesh flap is configured to absorb, deflect, or block microwave energy, and
wherein the at least one outlet movable mesh flap is configured to be deflected as the quantity of biomass material passes through the outlet suppression tunnel and then to return to a resting, closed position when the quantity of biomass material is no longer passing through the outlet suppression tunnel.

Embodiment 101. The method of embodiment 100, wherein the outlet movable mesh flap comprises stainless steel.

Embodiment 102. The method of embodiment 95, wherein the processing of the biomass material operates continuously.

Embodiment 103. A method for sharing portable biomass material processing, comprising:
receiving a request for processing a first quantity of biomass material at a first location and a second location separate from the first location;
determining that the first location has a first group of characteristics;
determining that the second location has a second group of characteristics
deploying a portable system for processing biomass material at the first location or the second location based on at least the first quantity of biomass material and the first group of characteristics or the second quantity of biomass material and the second group of characteristics, the portable system comprising:

at least one power generator configured to provide at least the first power output,

at least one microwave generator operatively coupled to the power generator,

at least one conveyor unit configured to receive and process a quantity of biomass material to achieve at least a target temperature for a target time; and
applying microwave energy to the first or second quantity biomass material within the conveyor unit of the portable system.

Embodiment 104. The method of embodiment 103, wherein the target temperature achieved by the quantity of biomass material and the target time are defined based on a desired degree of chemical and/or mechanical processing to be experienced by at least a portion of the quantity of biomass material.

Embodiment 105. The system, apparatus, or method of any preceding embodiment, wherein the quantity of biomass material is cooled to a temperature lower than ambient temperature prior to the first conveyor unit receiving and processing the quantity of biomass material.

Embodiment 106. The system, apparatus, or method of embodiment 105, wherein a quantity of liquid is added to the quantity of biomass material prior to the cooling.

Embodiment 107. The system, apparatus, or method of embodiment 106 or 107, wherein the cooling comprises at least some freezing.

Embodiment 108. The system, apparatus, or method of any preceding embodiment, wherein the quantity of biomass material is formed into pellets and/or briquettes after or during heating.

Embodiment 109. The system, apparatus, or method of embodiment 108, wherein the pellets and/or briquettes are storable and transportable using conventional and existing logistics.

Embodiment 110. The system, apparatus, or method of embodiment 108, wherein the pellets and/or briquettes are formed following a pyrolysis, gasification, and torrefaction, homogenization (including at least partial equalization of energetic homogeneity), densification (including improving energy density), and/or volume reduction, of the biomass material.

Embodiment 111. The system, apparatus, or method of embodiment 108, wherein the pellets and/or briquettes are transported to a location for combustion to release stored thermal energy.

Embodiment 112. The system, apparatus, or method of any preceding embodiment, wherein the heating the biomass material comprises a thermal conversion.

Embodiment 113. A system for processing biomass material, comprising:
at least one microwave generator;
at least one microwave guide operatively connecting the at least one microwave generator to at least a first conveyor unit, the first conveyor unit provided in a first housing that comprises at least one opening configured to receive microwave energy via a first microwave guide, wherein the first conveyor unit is configured to receive and process a quantity of biomass material, which includes heating the biomass material to a first temperature by applying microwave energy to the biomass material within the first housing; and
a fluidized bed reactor, wherein the fluidized bed reactor is configured to receive the biomass material after processing at the first conveyor unit.

Embodiment 114. The system of embodiment 113, wherein the fluidized bed reactor comprises a bubbling fluidized bed.

Embodiment 115. The system of embodiment 113, wherein the fluidized bed reactor comprises a circulating fluidized bed.

Embodiment 116. The system of embodiment 113, wherein the fluidized bed reactor comprises a rotating cone reactor.

Embodiment 117. The system of embodiment 113, wherein the fluidized bed reactor comprises a vacuum reactor.

Embodiment 118. The system of embodiment 113, wherein the fluidized bed reactor comprises an ablative reactor.

Embodiment 119. The system of embodiment 113, wherein the fluidized bed reactor comprises an auger reactor.

Embodiment 120. A method of processing material, comprising:
receiving a quantity of biomass material at a first conveyor unit provided in a first housing;
performing a first processing step to the quantity of biomass material within the first conveyor unit using at least one microwave generator coupled to the housing of the first conveyor unit, wherein the biomass material is heated within the first conveyor unit; and
performing a second processing step to the quantity of biomass material at a fluidized bed reactor.

Embodiment 121. An apparatus for processing biomass material, comprising:
a conveyor unit comprising a helical auger having an auger shaft provided along an auger rotational axis, the auger configured to rotate in a direction such that a quantity of biomass material received at the conveyor unit is caused to be transported according the auger rotational axis; and
at least one microwave energy generator, each microwave energy generator being operatively connected to a respective microwave guide configured to cause microwaves emitted by the microwave energy generator to heat the biomass material within the conveyor unit by converting the microwaves to heat when absorbed by at least a portion of the quantity of biomass material within the conveyor unit;
wherein the quantity of biomass material is heated using the microwave energy, and wherein the quantity of biomass material is caused to exit the conveyor unit and enter a fluidized bed reactor after being heated to a first temperature, wherein the fluidized bed reactor is configured to heat the biomass material to a second temperature.

Embodiment 122. A method of processing material using microwave energy, comprising:
receiving a quantity of biomass material at a conveyor unit comprising an auger, wherein the biomass material passes through at an inlet microwave suppression tunnel before entering the conveyor unit;
transporting the quantity of biomass material along the conveyor unit by causing the auger to rotate;
heating the quantity of biomass material within the conveyor unit using at least one microwave generator operatively connected to a respective microwave guide configured to cause microwaves emitted by the microwave energy generator to heat the quantity of biomass material within the conveyor unit by converting the microwaves to heat when absorbed by at least a portion of the quantity of biomass material within the conveyor unit;
causing the heated quantity of biomass material to exit the conveyor unit through an outlet microwave suppression tunnel, wherein the quantity of biomass material that exits the conveyor unit is a chemically-treated product; and
heating the chemically-treated product using a fluidized bed reactor.

Embodiment 123. An apparatus, system, or method of any embodiment above, wherein energy is produced using the fluidized bed reactor.

Embodiment 124. The apparatus, system, or method of any embodiment above, wherein the energy comprises electrical and/or thermal energy.

Embodiment 125. A system for processing biomass material, comprising:
at least one microwave generator;
a fluidized bed reactor, at least one microwave guide operatively connecting the at least one microwave generator to at least a first conveyor unit, the first conveyor unit provided in a first housing that comprises at least one opening configured to receive microwave energy via a first microwave guide, wherein the first conveyor unit is configured to receive and process a quantity of biomass material, which includes heating the biomass material to a first temperature by applying microwave energy to the biomass material within the first housing; and
wherein the fluidized bed reactor is configured to operate to assist the processing of the biomass material during processing at the first conveyor unit.

Embodiment 126. The system of embodiment 125, wherein the first conveyor unit and the fluidized bed reactor are formed as a single biomass processing unit.

Embodiment 127. An apparatus, system, or method of any embodiment above, wherein a bio-oil, biochar, gas, or combustible oil is produced from the biomass material.

1. A system for processing biomass material, comprising:
a material inlet and a material outlet;
at least a first conveyor unit associated with at least one of the material inlet and the material outlet;
at least one microwave generator;
at least a first microwave guide operatively connecting the at least one microwave generator to at least the first conveyor unit,
wherein the first conveyor unit is provided in a first housing that comprises at least one microwave opening configured to receive microwave energy via at least the first microwave guide; and
at least one microwave suppression system associated with the first conveyor unit, each microwave suppression system comprising:
a tunnel associated with at least one of the material inlet and the material outlet, and
at least one flexible and/or movable microwave reflecting component comprised within the tunnel,
wherein at least a portion of the at least one microwave reflecting component is configured to be deflected as a quantity of biomass material passes through the tunnel and then to return to a resting, closed position when the biomass material is no longer passing through the tunnel,
wherein the first conveyor unit is configured to receive and process the biomass material, the processing comprising heating the biomass material to at least a first temperature by applying microwave energy to the biomass material within the first housing.

2. The system of claim 1, wherein the first temperature is a reaction temperature of the biomass material, and wherein the heating the biomass material to the first temperature at least partially causes the biomass material to undergo a chemical reaction, chemical treatment, drying, or thermal conversion.

3. The system of claim 2, wherein the first temperature is a target temperature is based on desired chemical properties of the biomass material after processing, and wherein the chemical reaction, chemical treatment, drying, or thermal conversion comprises at least one of pyrolysis, torrefaction, gasification, and liquefaction.

4. The system of claim 1, wherein the biomass material is heated to the first temperature for a first time period within the first housing.

5. The system of claim 1, further comprising an apparatus configured to receive the biomass material and produce pellets, briquettes, bio-oil, biochar, gas, and/or other combustible oil based on the received biomass material.

6. The system of claim 1, further comprising a second conveyor unit, the second conveyor unit provided in a second housing that comprises at least one microwave opening configured to receive microwave energy via at least a second microwave guide, wherein the second conveyor is configured to receive and process the biomass material, which includes heating the biomass material to a second temperature greater than the first temperature by applying microwave energy to the material within the second housing.

7. The system of claim 1, wherein the movable microwave reflecting component is a mesh flap comprising stainless steel.

8. The system of claim 1, further comprising at least a second microwave suppression system.

9. The system of claim 1, further comprising a mechanical processing apparatus associated with the first conveyor unit, wherein the biomass material enters a conveyor unit before entering or after exiting the mechanical processing apparatus, wherein the mechanical processing apparatus is a mill, crusher, a mixer, a loader unit, an impactor, a shredder, a mesh, a screen, a brush, a sorting apparatus, a blender, a lifting apparatus, a homogenizing apparatus, or an apparatus configured to reduce a maximum largest dimension and/or increase the density the biomass material being processed.

10. The system of claim 1, wherein the biomass material to be processed contains at least a first water percentage by weight, and the first water percentage by weight of the biomass material is reduced to a second water percentage by weight lower than the first water percentage by weight during or after the processing.

11. The system of claim 1, further comprising at least one heat exchanger apparatus configured to recover a heat byproduct from the material being processed.

12. The system of claim 1, wherein the system is modular and portable.

13. The system of claim 1, wherein the system is configured to process the biomass material continuously or in batches.

14. The system of claim 13, wherein the system is configured to process the biomass material continuously, and wherein a processing speed of the system is adjustable such that the speed can be reduced to increase heating, or can be increased to reduce heating of the biomass material being processed within the at least one conveyor unit.

15. The system of claim 1, wherein the biomass material is cooled to a temperature lower than an ambient temperature prior to the first conveyor unit receiving and processing the biomass material.

16. The system of claim 1, further comprising a fluidized bed reactor, wherein the fluidized bed reactor is configured to receive the biomass material during or after processing at the first conveyor unit.

17. The system of claim 16, wherein the fluidized bed reactor comprises at least one of a bubbling fluidized bed, a circulating fluidized bed, a rotating cone reactor, a vacuum reactor, an ablative reactor, and an auger reactor.

18. The system of claim 16, wherein the first conveyor unit and the fluidized bed reactor are formed as a single biomass processing unit.

19. An apparatus for processing biomass material, comprising:
a material inlet and a material outlet;
a conveyor unit comprising an auger having an auger shaft provided along an auger rotational axis, the auger configured to rotate in a direction such that a quantity of biomass material received at the conveyor unit is caused to be transported according to the auger rotational axis;
at least one microwave energy generator, each microwave energy generator being operatively connected to at least a respective microwave guide configured to cause microwaves emitted by the microwave energy generator to heat the biomass material within the conveyor unit by converting the microwaves to heat when absorbed by at least a portion of the biomass material within the conveyor unit; and
at least a first microwave suppression system comprising a tunnel associated with at least one of the material inlet and material outlet, wherein the first microwave suppression system comprises at least one flexible and/or movable microwave reflecting component within the tunnel, wherein the at least one microwave reflecting component is configured to absorb, deflect, or block microwave energy, and wherein the at least one microwave reflecting component is configured to be deflected as the biomass material passes through the tunnel and then to return to a resting, closed position when the biomass material is no longer passing through the tunnel,
wherein the biomass material is heated using the microwave energy, and wherein the biomass material is caused to be heated to at least a first temperature by the microwaves emitted by the at least one microwave generator.

20. A method of processing biomass material using microwave energy, comprising:
receiving a quantity of biomass material at a conveyor unit, wherein the biomass material passes through at an inlet microwave suppression tunnel before entering the conveyor unit, wherein the inlet microwave suppression tunnel comprises at least one flexible and/or movable inlet microwave reflecting component within the inlet microwave suppression tunnel, and wherein the at least one inlet microwave reflecting component is configured to absorb, deflect, or block microwave energy;
deflecting the at least one inlet microwave reflecting component as the biomass material passes through the inlet microwave suppression tunnel and then optionally returning the at least one inlet microwave reflecting component to a resting, closed position when the biomass material is no longer passing through the inlet microwave suppression tunnel;
transporting the biomass material using at least the conveyor unit;
heating the biomass material within at least the conveyor unit using at least one microwave generator operatively connected to a respective microwave guide configured to cause microwaves emitted by the microwave energy generator to heat the biomass material within at least the conveyor unit by converting the microwaves to heat when absorbed by at least a portion of the biomass material within at least the conveyor unit; and
causing the biomass material to exit through an outlet microwave suppression tunnel after the biomass material is heated such that the biomass material: a) reaches a first temperature and/or b) undergoes a reaction within at least the conveyor unit.
